(19) United States
(12) Patent Application Publication
(10) Pub. No.: US 2018/0302914 A1
(43) Pub. Date: Oct. 18, 2018

(54) Methods and Apparatus for Managing Small Data Transmissions from User Equipments, for Managing Radio Resource Control States of User Equipments, and for Managing a Radio Resource Control Context and State of User Equipments

(71) Applicant: Telefonaktiebolaget LM Ericsson (publ), Stockholm (SE)

(72) Inventors: Icaro L. J. da Silva, Solna (SE); Jan Christoffersson, Luleå (SE)

(21) Appl. No.: 15/566,482

(22) PCT Filed: Aug. 16, 2017
(86) PCT No.: PCT/SE2017/050825

§ 371 Date: Oct. 13, 2017

Related U.S. Application Data
(60) Provisional application No. 62/417,694, filed on Nov. 4, 2016.
(60) Provisional application No. 62/417,666, filed on Nov. 4, 2016.
(60) Provisional application No. 62/417,613, filed on Nov. 4, 2016.

(51) Int. Cl. H04W 72/12; H04W 76/27; H04W 74/08

(52) U.S. Cl. CPC H04W 72/1268; H04W 76/27; H04W 72/1252; H04W 72/1289; H04W 74/08

(57) ABSTRACT

A method for managing small data transmissions from a User Equipment (UE) is disclosed. The method comprises configuring the UE with a timer, wherein the timer expires after a threshold period of time. The method also comprises instructing the UE to reset the timer after each small data transmission by the UE, and, once the timer has been reset, to refrain from making any additional small data transmissions until the timer has expired.

Also disclosed is a method for a UE to manage its small data transmissions. The method comprises obtaining configuration details for a timer, wherein the timer expires after a threshold period of time. The method also comprises resetting the timer after sending a small data transmission and refraining from sending any additional small data transmissions until the time has expired.

### TECHNICAL FIELD

The present disclosure relates to methods for managing small data transmissions from a User Equipment (UE). The disclosure also relates to methods for a UE to manage its small data transmissions, and to apparatus and to a computer program configured to carry out methods for managing small data transmissions from a UE. The disclosure further relates to methods for managing a Radio Resource Control (RRC) state of a UE. The disclosure also relates to methods for management by a UE of its RRC state, and to apparatus and to a computer program configured to carry out methods for managing an RRC state of a UE. The disclosure further relates to methods for managing an RRC context of a UE. The disclosure also relates to methods for managing an RRC state of a UE, and to apparatus and to a computer program configured to carry out methods for managing an RRC context and an RRC state of a UE.

### BACKGROUND

Next generation telecommunications and networking systems are expected to support a wide range of use cases with varying requirements ranging from fully mobile devices to stationary Internet of Things (IoT) or fixed wireless broadband devices. The traffic pattern associated with many use cases for next generation systems is expected to consist of short or long bursts of data traffic with varying length waiting periods between transmissions. For such traffic it is important to optimize the state between the data bursts, often referred to as an inactive state, as well as the transition to active state, in which data transmissions are made.

Small data transmission is of considerable interest as a component of overall traffic pattern, as cumulated small data transmission traffic represents a significant proportion of the overall network traffic, owing in large part to the high market penetration of smartphones. The majority of overhead for small data transmission is the signaling overhead for radio connection setup which is required even before transmission of one small data block. The relatively large overhead for a small data transmission is a common issue for both Long Term Evolution (LTE) and the next generation New Radio Access Technology (NR).

In order to reduce signaling overhead and the associated processing load in the network for small data transmission, Service and System Aspects (SA)2 and Radio Access Network (RAN) Working Groups concluded that a solution for LTE would be introduced in Release 13, the solution allowing a Radio Resource Control (RRC) connection to be suspended and subsequently resumed, thus minimizing the need to go through the full signaling procedure for transitioning from an idle state RRC_IDLE to a connected state RRC CONNECTED for small data transmissions. The Suspend/Resume procedure is applicable both to normal LTE User Equipments (UEs) and IoT UEs.

The RRC Suspend/Resume procedure is based on enhancements to the RRC_IDLE state making it possible to resume an RRC connection without needing to set the connection up again when the UE returns from an idle state, assuming that a majority of the time, a UE will return to connected state in a cell serviced by a node which has stored the RRC context for the UE. The RRC Suspend/Resume procedure uses a UE RRC context, also referred to as an Access Stratum (AS) context. The UE RRC context is stored both in the RAN and in the UE. When a UE initiates an RRC Resume procedure, for example to transmit small data, the eNB receiving the RRC Resume Request will either have the context available or will fetch it from another node where it was stored when the UE was suspended. The UE RRC context or AS Context contains information needed for the UE and network to resume the RRC connection. This includes security parameters such as encryption keys, parameters for Signaling Radio Bearers (SRBs) and Data Radio Bearers (DRBs) (Packet Data Convergence Protocol (PDCP) and Radio Link Control (RLC) configurations) and measurement configurations.

The RRC Suspend/Resume procedure is illustrated in FIG. 1 between a UE and an eNodeB (eNB). Referring to FIG. 1, the procedure starts with a Random Access request. This is partly required as the Uplink (UL) synchronization cannot be guaranteed as a result of UE inactivity (that is the suspension of the RRC connection) and the fact that the UE may have moved to a new position, requiring adjustment of the timing offset for UL synchronization, or may have moved to a new cell or tracking area.

Upon reception of Random Access Channel (RACH) preamble, the eNB sends a Re-activation Request (RAR) message include a timing advance (TA) value for UL timing and a grant for SRB0, which is needed for the RRC connection re-activation request transmission. The SRB0 is used to carry Common Control Channel (CCCH) signaling, without the support of security functionalities as is required for other types of SRBs and DRBs.

When the RRC connection re-activation request message is successfully transmitted to the UE (RRCConnectionResumeRequest, according to TS 36.331) the UE will activate its RRC context. From this point in the procedure, SRBs and DRBs are encrypted, as the activated UE RRC context contains configuration parameters for SRBs and DRBs (PDCP/RLC parameters), encryption keys and measurement configurations. The eNB also activates the UEs RRC context and replies with an RRC connection re-activation message to the UE (RRCConnectionResume). This message may also include grants for the DRB used for data transmission. Upon receiving this message the UE enters the RRC_CONNECTED state.

Finally, the UE responds with an RRC connection re-activation complete message and the UE is then ready for UL data transmission. When the UE has finished its transmission there will be signaling to in-activate the UEs RRC context and send the UE back to an inactive state again. This signaling may for example be triggered if the UE is inactive for a certain period of time.

It has been agreed that in the next generation NR there will be an inactive “state” with the following characteristics:
a/t CN/RAN connection is maintained
b/AS context is stored in the RAN
c/Network knows a UE's location within an area and the UE performs mobility within that area without notifying the network.
d/RAN can trigger paging of UEs which are in the RAN controlled “inactive state”
e/No dedicated resources

In LTE Release 14, under the RRC light connection working item, the solution based on Suspend/Resume described above and illustrated in FIG. 1 appears to be evolving in the same direction as the NR inactive state, with very similar characteristics also being assumed for the UE when the RRC context is suspended. This is illustrated in FIG. 2.

In recent work, progress has been made on UE state assumptions for NR. It has been agreed that an inactive state will be introduced, in which a UE should be able to start data transfer with low delay (as dictated by RAN requirements). One of the open issues concerned data transmission when UEs are in the inactive state, with the question of whether data transfer is accomplished by the UE leaving the inactive state, or can take place with the UE in the inactive state, being held over for further study. This question has now been partially resolved, with agreement that in the inactive state there will be a mechanism where the UE first transitions to the full connected state in which data transmission can occur. However, for the special case of small data transmissions, a possibility for the UE to perform data transmission without state transition from the inactive state to the connected state is considered.

### SUMMARY

Examples of the present disclosure provide methods addressing the management of small data transmission from UEs.

For example, in one aspect the disclosure provides a method for managing small data transmissions from a User Equipment (UE). The method comprises: configuring the UE with a timer, wherein the timer expires after a threshold period of time; and instructing the UE to: reset the timer after each small data transmission by the UE; and once the timer has been reset, refrain from making any additional small data transmissions until the timer has expired.

In another aspect, the disclosure provides a method for a User Equipment (UE) to manage its small data transmissions. The method comprises: obtaining configuration details for a timer, wherein the timer expires after a threshold period of time; resetting the timer after sending a small data transmission; and refraining from sending any additional small data transmissions until the timer has expired.

A further aspect of the disclosure provides a method for managing a Radio Resource Control (RRC) state of a User Equipment (UE). The method comprises: learning a behaviour of the UE with respect to small data transmissions; determining from the learned behaviour whether a network performance condition for requiring the UE to be in a Connected state following receipt of a small data transmission from the UE is met; and, if the condition is met, placing the UE in a Connected state following receipt of a small data transmission from the UE.

In another aspect, the disclosure provides a method for management by a User Equipment (UE) of its Radio Resource Control (RRC) state. The method comprises: retrieving a time window and a first threshold value for a number of indications that the UE wishes to be in an Inactive state following a small data transmission that may be received from the UE within the time window; monitoring a number of indications that the UE wishes to be in an Inactive state following a small data transmission sent by the UE; and on reaching the threshold number of indications, omitting to send any further indications until expiry of the time window.

In a further aspect, the disclosure provides a method for managing a Radio Resource Control (RRC) context of a User Equipment (UE). The method comprises: storing, in the RRC context for the UE, information for determining whether to allow the UE to be in an Inactive state.

Another aspect provides a method for managing a Radio Resource Control (RRC) state of a User Equipment (UE). The method comprises: receiving an indication from the UE that the UE wishes to be in an Inactive state; retrieving, from an RRC context for the UE, information for determining whether to allow the UE to be in an Inactive state; determining whether to allow the UE to be in the Inactive state on the basis of the retrieved information; and, if it is determined to allow the UE to be in the Inactive state, placing the UE in the inactive state.

The present disclosure further provides a computer program comprising instructions which, when executed on at least one processor, cause the at least one processor to carry out any of the methods set out above. A computer program product is also provided, comprising non transitory computer readable media having such a computer program stored thereon.

In further aspects, the present disclosure provides apparatus suitable for carrying out any of the methods described above, or configured to carry out any of the methods described above. For example, the apparatus may comprise any of user equipments, radio access nodes, or nodes implementing virtual network functions. Note that the discussion below focuses on a technical solution for LTE and those networks intended to meet the requirements set out for the fifth generation (5G) of wireless systems, as defined by the Next Generation Mobile Networks Alliance. However, those skilled in the art will appreciate that it is also possible to apply the methods and apparatus described herein to other networks and access technologies. In other networks, nodes and interfaces may have different names.

### BRIEF DESCRIPTION OF THE DRAWINGS

For a better understanding of the present disclosure, and to show more clearly how it may be carried into effect, reference will now be made, by way of example, to the following drawings, in which:

FIG. 1 is a signalling diagram illustrating an RRC Resume procedure;

FIG. 2 is a representation of RRC states;

FIG. 3 is a signalling diagram illustrating a procedure for sending small data transmissions;

FIG. 4 is a flow diagram illustrating process steps in a method for managing small data transmissions from a UE;

FIG. 5 is a signalling diagram illustrating implementation of a method for managing small data transmissions from a UE;

FIG. 6 is a flow diagram illustrating process steps in a method for a UE to manage its small data transmissions;

FIG. 7 is a flow diagram illustrating an example implementation of the method of FIG. 6;

FIG. 8 is a timing diagram illustrating implementation of the methods of FIGS. 4 and 6;

FIG. 9 is a block diagram illustrating functional units in an apparatus;

FIG. 10 is a block diagram illustrating functional units in another example of apparatus;

FIG. 11 is a block diagram illustrating functional units in another example of apparatus;

FIG. 12 is a block diagram illustrating functional units in another example of apparatus;

FIG. 13 is a flow chart illustrating process steps in a method for managing an RRC state of a UE;

FIG. 13a is a further flow chart illustrating process steps in a method for managing an RRC state of a UE;

FIG. 14 is a signalling diagram illustrating a learning phase;

FIG. 15 is a signalling diagram illustrating management of an RRC state of a UE;

FIG. 16 is a flow chart illustrating process steps in a method for management by a UE of its RRC state;

FIG. 17 is a block diagram illustrating functional units in an apparatus;

FIG. 18 is a block diagram illustrating functional units in another example of apparatus;

FIG. 19 is a block diagram illustrating functional units in another example of apparatus;

FIG. 20 is a block diagram illustrating functional units in another example of apparatus;

FIG. 21 is a signalling diagram illustrating a UE method;

FIG. 22 is a flow diagram illustrating process steps in a method for managing an RRC context of a UE;

FIG. 23 is a flow diagram illustrating process steps in a method for managing an RRC state of a UE;

FIG. 24 is a block diagram illustrating functional units in an apparatus;

FIG. 25 is a block diagram illustrating functional units in another example of apparatus;

FIG. 26 is a block diagram illustrating functional units in another example of apparatus; and

FIG. 27 is a block diagram illustrating functional units in another example of apparatus.

### DETAILED DESCRIPTION

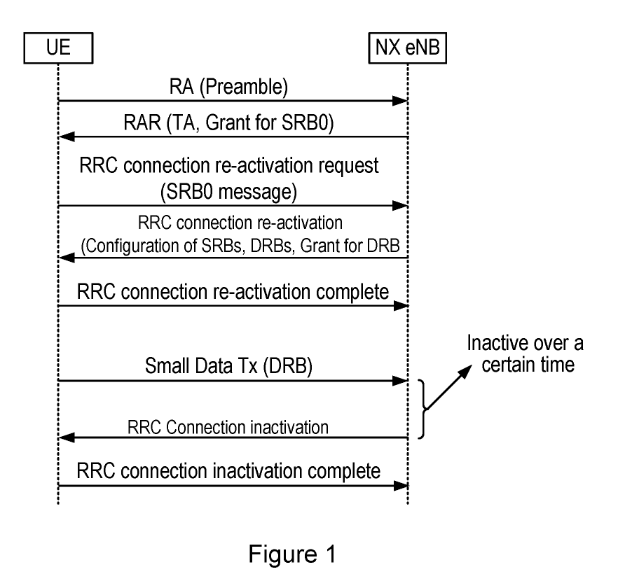

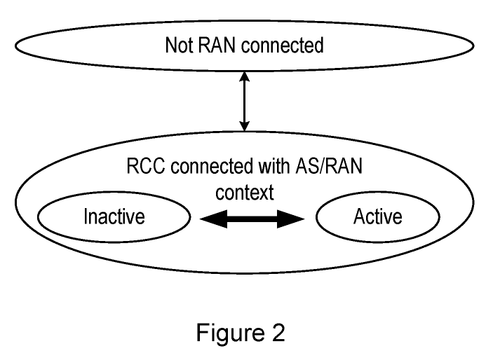

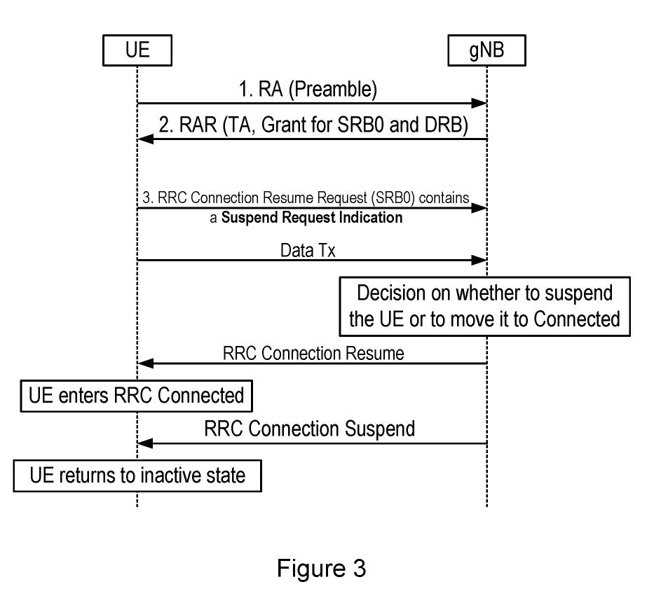

A first mechanism for data transmission by a UE without state transition, as envisaged for the new inactive state, comprises transmitting data in conjunction with message 3 of the RRC Suspend/Resume procedure illustrated in FIG. 1, i.e. together with the RRC Connection Re-activation Request. The main steps of this mechanism are illustrated in FIG. 3 and outlined below. For consistency with NR terminology, in FIG. 3 the eNB participating in the Suspend/Resume procedure is illustrated as a gNB.

The Random access response message (message 2) contains a grant large enough to allow the UE to transmit both the RRC Connection resume request and a small data packet.

If the UE only has one small packet to transmit, signaling may be further simplified, with the UE possibly not needing to activate the entire RRC context. For example, initiating DL measurements may be unnecessary when transmitting only a single small UL packet.

The small data could be sent simultaneously (that is multiplexed on the same Transport Block (TB)) with the RRC Connection resume request that activates the context. The data transmission could be sent on a shared/contention based, and always active, DRB.

If the UE only has one small packet to transmit, the context could be in-activated immediately after the transmission or after a timer expiration without any extra in-activation signaling. The RRC response also serves as a contention resolution message, i.e. acknowledging the successful reception of the packet.

In addition to first packet latency, one advantage of this type of solution is the efficient support for infrequent transmissions. A UE could also indicate in the RRCConnectionResumeRequest message that the UE wishes immediately to return to the inactive state instead of moving to the connected state, as is the case in the procedure of FIG. 1. Remaining in the inactive state is sensible if these small transmissions are also infrequent. If there are long time gaps between transmissions then it is inefficient to move the UE to the connected state, wait for some inactivity timer to expire and then move the UE back to the inactive state. With no subsequent data transmissions during the inactivity timer, there is no advantage to be gained from placing the UE in the connected state, and during this time the UE would be performing connected state procedures, including measurements and reporting, which consume UE battery.

In the procedure discussed above and illustrated in FIG. 3, the UE starts with a random access procedure but the data included with message 3 is transmitted over an orthogonal scheme (e.g. PUSCH/PUCCH) thanks to the UL grants provided by the eNB. An alternative procedure would be to use a Contention-Based (CB) channel to directly send data with message 3 (possibly including on this channel the indication that the UE wishes to immediately return to the inactive state). In this case the UE either needs to be pre-configured on how to use the CB channel or to read the configuration via system information. Another alternative procedure would be for the UE to transmit infrequent small data directly on a CB channel without any RRC signaling. A CB channel would therefore be defined that can be used for small infrequent data and that UEs can access in the inactive state.

When a UE is in the RRC Connected state, the network has a better control of the resources being used by and for the UE than when the UE is in an inactive or idle state. In addition, when a UE is in the Connected state the network can properly apply Quality of Service (QoS) treatment of different flows and for different UEs, perform link adaptation, beam management, session continuity, etc. From a resource efficiency perspective, in the case of data transmissions that are frequent, it is consequently beneficial to the network to keep UEs in the RRC Connected state rather than allowing them to enter the inactive state in which the network has a more limited control of its resources. This may also be beneficial to the UEs. This reasoning applies to all of the solutions for infrequent small data transmissions described below. For example, in the case of a small data transmission using a CB channel there may also be resource issues in the form of collisions if UEs with frequent small data transmissions use this channel. As the channel would typically be dimensioned only for infrequent small data transmissions, the channel would risk becoming occupied and blocked by frequent small data transmissions which would be better served by placing the relevant UEs into a Connected state.

Considering the question of UE management of its battery resources, it may be beneficial for the UE to remain in an inactive state, even in some cases sacrificing some performance, in order to save battery power and have more UE-controlled features including for example UE-based mobility.

There is consequently a potential conflict of interest between a network, which wishes to move UEs to the Connected state when they have more frequent data, and the UEs themselves, which may wish to remain in an inactive state despite potentially having frequent data transmissions.

A potential scenario is that a UE has small but frequent data, receives an UL resource grant sends an RRCConnectionResumeRequest message with the data and an indication that the UE does not in fact wish to transition to the Connected state but wishes to remain in the inactive state. The network assumes on the basis of this indication that UE has infrequent data transmissions, which may not always be the case, for example if UEs are not properly optimized to estimate when the traffic is really infrequent and/or if UEs always try to opportunistically remain in Inactive state. In such a situation, the network would be providing UL resources without being able to ensure that the UEs have infrequent data transmissions, and may be providing resources in an inefficient manner.

Examples of the present disclosure address the above conflict by preventing UEs from using small data transmissions procedures too frequently. Examples of the present disclosure thus provide a method for managing small data transmissions from a UE.

A small data transmission may comprise a data transmission by a UE that follows a small data transmission procedure. A small data transmission procedure may comprise, for a UE in an Inactive state, transmitting an amount of data without entering a Connected state. The Inactive state may for example be a newly defined state RRC_INACTIVE or may be the Suspended mode of the state RRC_IDLE.

Transmitting an amount of data without entering a Connected state may comprise at least one of: including the data with Radio Resource Control (RRC) signalling; and transmitting the data on a Contention Based (CB) channel that is reserved for small infrequent data transmissions and may be accessed by UEs in an Inactive state. Including the data with RRC signalling may comprise including the data with an RRC Connection Re-activation Request.

Transmitting an amount of data without entering a Connected state may further comprise including with the RRC Connection Re-activation request an indication that the UE wishes to remain in the Inactive state. The indication that the UE wishes to remain in the Inactive state may comprise at least one of an indication that the UE has no further UL data to transmit, and/or an explicit request to remain in the Inactive state. An indication that the UE has no further UL data to transmit may for example comprise a Buffer Status Report (BSR).

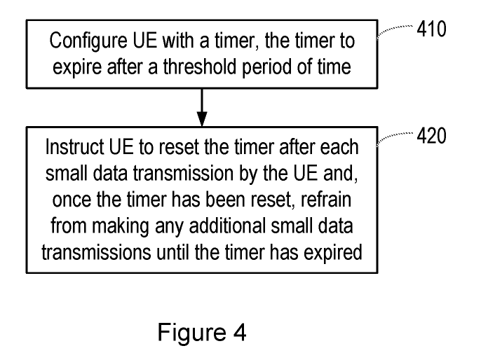

A flow chart illustrating process steps in such a method is illustrated in FIG. 4. Referring to FIG. 4, in a first step 410, the method comprises configuring the UE with a timer, wherein the timer expires after a threshold period of time.

Configuring the UE with a timer may comprise including configuration details for the timer with system information broadcast within a cell in which the UE is located. The configuration details may include a timer identifier and the threshold period of time after which the timer expires.

Alternatively, configuring the UE with a timer may comprise including configuration details for the timer with dedicated signalling for the UE. Including configuration details for the timer with dedicated signalling for the UE may comprise including the configuration details with RRC signalling for the UE. Specifically, including configuration details for the timer with dedicated signalling for the UE may comprise including the configuration details with an RRC Connection in-activation message.

The method may further comprise updating the threshold period of time after which the timer expires in accordance with at least one of: network conditions, network load, and UE traffic pattern. Updating the threshold period of time after which the timer expires may comprise one of: increasing the threshold period of time to reduce small data transmission load; or reducing the threshold period of time to increase small data transmission load.

The method then comprises, at step 420, instructing the UE to reset the timer after each small data transmission by the UE and, once the timer has been reset, to refrain from making any additional small data transmissions until the timer has expired.

The method may be implemented in a Radio Access Network, for example in a radio access node such as an eNodeB or gNodeB. In some examples, the method may be at least partially implemented as a Virtualised Network Function.

Small data transmission is a technical concept under study by the 3GPP and involved companies. For the purposes of the following discussion, a small data transmission comprises a transmission by a UE that follows a small data transmission procedure. A small data transmission procedure comprises a procedure used by UEs in an Inactive state which have an amount of data to transmit which is less than some threshold amount. The precise threshold for the amount of data may vary widely according to different applications, situations and use cases. The procedure allows a UE to send the data without first transitioning to a Connected state. The Connected state is the RRC Connected state, and the Inactive state may be either a newly defined state RRC_INACTIVE, as discussed above, or may be the Suspended mode of the state RRC_IDLE.

Examples of the present disclosure provide a method according to which an access network configures a UE with a timer that is used to prevent UEs from using the optimized mechanism to send small data when in the Inactive state too frequently, as this procedure is supposed to be used only for transmissions that are both small and infrequent.

The timer may be configured via system information and may be associated to a given cell to which the UE is trying to transmit small data. Alternatively, the timer may be configured via dedicated signalling, for example in the RRC Suspend message as part of the UE transition to the Inactive state.

The timer is triggered when the UE transmits a first Uplink (UL) packet with small data in inactive state via a small data transmission procedure. This may be using the suspend/resume mechanism described above, with the UE indicating that it wishes to remain in the Inactive state, or may be directly via a contention-based channel. The timer is configured by the network and as discussed above the timer settings be sent to the UE using ordinary RRC signalling or in system information. The settings may be dynamically changed by the network depending on system load or traffic pattern of a UE. For example, if small data transmissions are consuming large part of the available resources, the timer setting may be increased to lower the small data load.

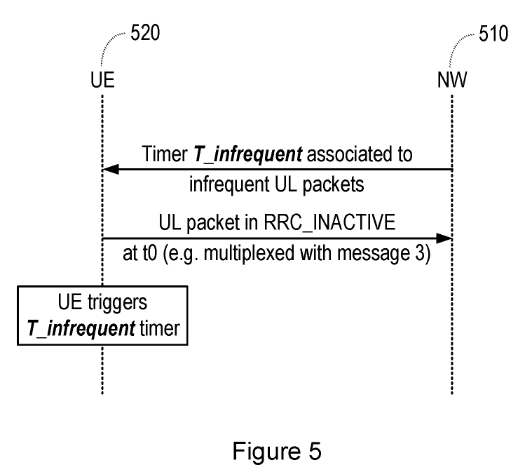

FIG. 5 is a signalling diagram illustrating a network 510 configuring a timer “T_infrequent” in a UE 520, and the UE 520 triggering the timer when it sends its next small data transmission.

Examples of the present disclosure also provide a method for a UE to manage its small data transmissions. A small data transmission may comprise a data transmission by a UE that follows a small data transmission procedure. A small data transmission procedure may comprise, for a UE in an Inactive state, transmitting an amount of data without entering a Connected state. The Inactive state may for example be a newly defined state RRC_INACTIVE or may be the Suspended mode of the state RRC_IDLE.

Transmitting an amount of data without entering a Connected state may comprise at least one of: including the data with Radio Resource Control (RRC) signalling; and transmitting the data on a Contention Based (CB) channel that is reserved for small infrequent data transmissions and may be accessed by UEs in an Inactive state. Including the data with RRC signalling may comprise including the data with an RRC Connection Re-activation Request. Transmitting an amount of data without entering a Connected state may further comprise including with the RRC Connection Re-activation request an indication that the UE wishes to remain in the Inactive state.

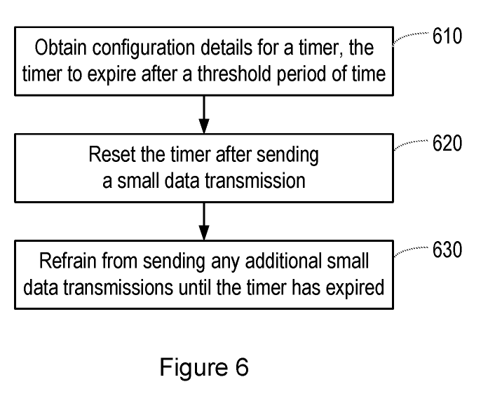

Such a method is illustrated in FIG. 6 and comprises, in a first step 610, obtaining configuration details for a timer, wherein the timer expires after a threshold period of time. In examples of the present disclosure, obtaining configuration details for a timer may comprise receiving the configuration details from a network node. The configuration details may be received via a system broadcast or via dedicated signalling between the network node and the UE. Alternatively, obtaining configuration details may comprise retrieving configuration details from a memory.

The method then comprises, in step 620, resetting the timer after sending a small data transmission, and, in step 630, refraining from sending any additional small data transmissions until the time has expired.

The method may further comprise obtaining updated configuration details for the timer, and applying the updated configuration details. The updated configuration details may include a new threshold time limit after which the time expires, and applying the updated configuration details may comprise applying the new threshold time limit to the timer when resetting the timer.

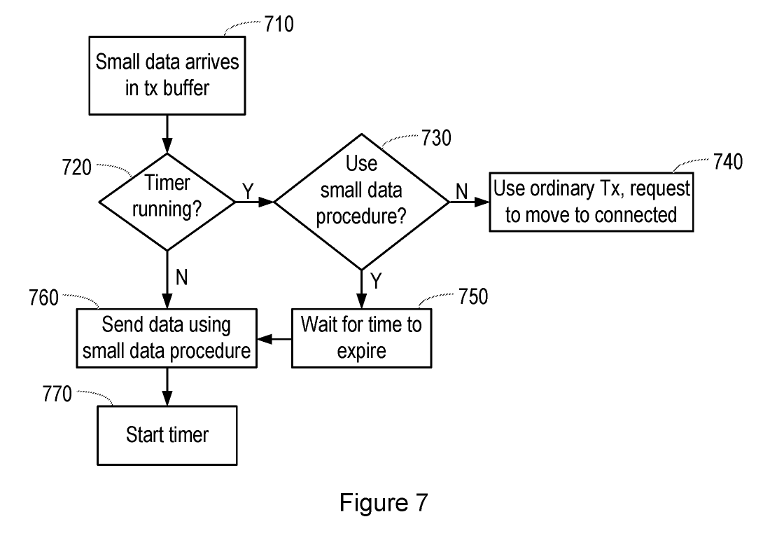

The process flow to be followed by a UE according to the method of FIG. 6 on receipt of data for transmission via a small data transmission procedure is illustrated in FIG. 7.

The procedure of FIG. 7 begins by identifying data for transmission, wherein the data is suitable for small data transmission. Referring to FIG. 7, in this example, the UE receives UL data in the transmission buffer at step 710, and determines that this data is suitable for small data transmission. The UE first checks if the timer is running in step 720 (i.e. if there has recently been a small data transmission). If the timer is running, the UE refrains from sending the data as a small data transmission. In this example, refraining from sending the data as a small data transmission comprises determining in step 730 whether delaying transmission of the data until the timer has expired is acceptable.

Thus, the UE decides in step 730 if it needs to transmit the data directly using the ordinary transmission procedure (requesting an up-switch to the Connected state) or if it can wait for the timer to expire and use the small data procedure (without requesting the up-switch). If the UE decides at step 730 that delaying transmission of the data until the timer has expired is not acceptable, and that it needs to transmit the data immediately, it uses the ordinary transmissions procedure at step 740. An ordinary data transmission may comprise a data transmission by a UE that follows an ordinary data transmission procedure. An ordinary data transmission procedure may comprise, for a UE in an Inactive state: requesting transition to a Connected state; and, on entering the Connected state, transmitting an amount of data.

If the UE decides at step 730 that the data does not need to be transmitted immediately, and the UE wishes to use the small data procedure, it waits until the timer expires in step 750. When the timer expires (or if it was determined in step 720 that the timer was not running), the UE transmits the data using the small data procedure at step 760 and resets and restarts the timer at step 770.

In examples of the present disclosure, determining whether delaying transmission of the data until the timer has expired is acceptable may comprise comparing a time remaining on the timer before expiry with a quality of service or other performance requirement for the data to be transmitted.

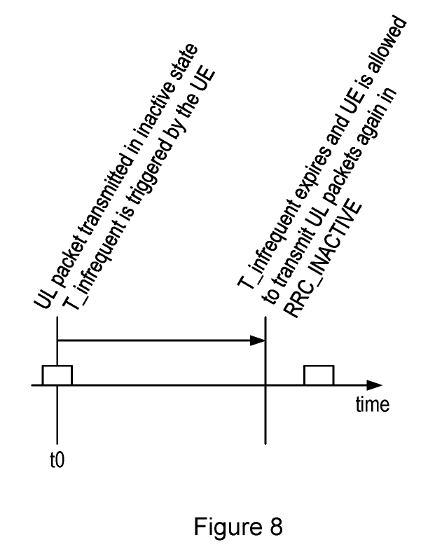

FIG. 8 is a timing diagram illustrating implementation of the above discussed methods. Referring to FIG. 8, a UE sends a small data transmission at time t0 and restarts its timer. Any packets for small data transmission that arrive in the UE transmission buffer while the timer is running are buffered until either network confirmation is received that the UE may transition to the Connected state and use ordinary transmission procedures to transmit the data, or until the timer expires, allowing the UE to use the small transmissions procedure again.

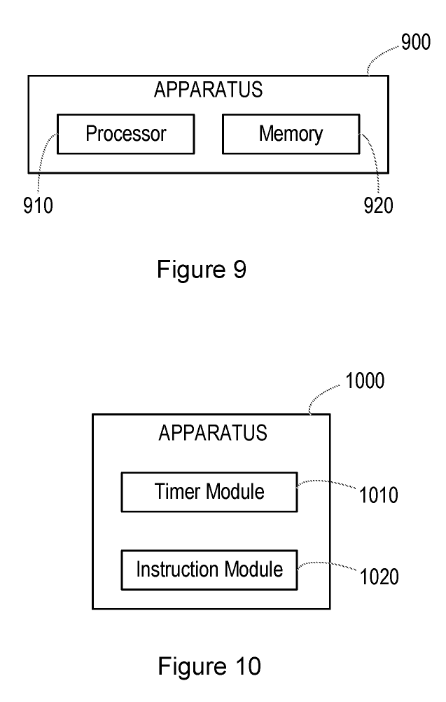

FIG. 9 illustrates a first example of an apparatus 900 which may carry out methods for managing small data transmissions from a UE as discussed above and as illustrated in FIGS. 4, 7 and 8. The apparatus 900 may carry out the methods for example on receipt of suitable instructions from a computer program. Referring to FIG. 9, the apparatus 900 comprises a processor 910 and a memory 920. The memory 920 contains instructions executable by the processor 910 such that the apparatus 900 is operative to conduct some or all of the steps of the methods for managing small data transmissions from UE described above and set out in the numbered paragraphs below.

FIG. 10 illustrates an alternative example apparatus 1000, which may implement methods for managing small data transmissions from a UE as discussed above and set out in the numbered paragraphs below, for example on receipt of suitable instructions from a computer program. It will be appreciated that the modules illustrated in FIG. 9 may be realised in any appropriate combination of hardware and/or software. For example, the modules may comprise one or more processors and one or more memories containing instructions executable by the one or more processors. The modules may be integrated to any degree.

Referring to FIG. 10, the apparatus 1000 comprises a timer module 1010 for configuring the UE with a timer, wherein the timer expires after a threshold period of time. The apparatus also comprises an instruction module 1020 for instructing the UE to reset the timer after each small data transmission by the UE and, once the timer has been reset, refrain from making any additional small data transmissions until the timer has expired.

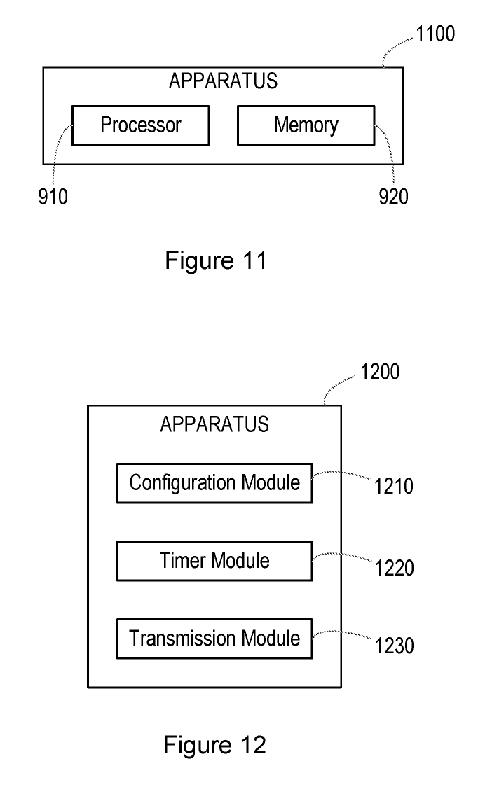

FIG. 11 illustrates a first example of an apparatus 1100 which may carry out a method for management by a UE of its small data transmissions as discussed above and as illustrated in FIG. 6 and FIGS. 5, 7 and 8. The apparatus 1100 may carry out the method for example on receipt of suitable instructions from a computer program. Referring to FIG. 11, the apparatus 1100 comprises a processor 1110 and a memory 1120. The memory 1120 contains instructions executable by the processor 1110 such that the apparatus 1100 is operative to conduct some or all of the steps of the method for management by a UE of its small data transmissions as discussed above and set out in the numbered paragraphs below.

FIG. 12 illustrates an alternative example apparatus 1200, which may implement a method for management by a UE of its small data transmissions as discussed above and set out in the numbered paragraphs below, for example on receipt of suitable instructions from a computer program. It will be appreciated that the modules illustrated in FIG. 12 may be realised in any appropriate combination of hardware and/or software. For example, the modules may comprise one or more processors and one or more memories containing instructions executable by the one or more processors. The modules may be integrated to any degree.

Referring to FIG. 12, the apparatus 1200 comprises a configuration module 1210 for obtaining configuration details for a timer, wherein the timer expires after a threshold period of time. The apparatus 1200 also comprises a timer module 1220 for resetting the timer after sending a small data transmission, and a transmission module 1230 for refraining from sending any additional small data transmissions until the time has expired.

Aspects of the present disclosure thus provide methods according to which a UE timer is defined, the timer prohibiting the UE from using a procedure for small data transmissions too frequently.

Examples of the present disclosure, particularly those described above with respect to FIGS. 4 to 12, enable a network to control how often a UE can use a small data transmission procedure, thus ensuring that such a procedure is not used for frequent traffic that would be better served with the UE in a Connected state. The network is thus better able to control the allocation of its resources and to reduce the risk that certain UEs will use a small data transmission procedure in a manner for which it is not intended, so making inefficient use of radio resources. This may for example occur when a UE seeks to use a small data transmissions procedure in order to save UE battery and/or because the UE is not able to estimate correctly whether or not that packets are infrequent.

Returning to a discussion of FIG. 3, as noted above, a potential scenario is that a UE has small but frequent data, receives an UL resource grant sends an RRCConnectionResumeRequest message with the data and an indication that the UE does not in fact wish to transition to the Connected state but wishes to remain in the inactive state. The network assumes on the basis of this indication that UE has infrequent data transmissions, which may not always be the case, for example if UEs are not properly optimized to estimate when the traffic is really infrequent and/or if UEs always try to opportunistically remain in Inactive state. In such a situation, the network would be providing UL resources without being able to ensure that the UEs have infrequent data transmissions. The question of whether a network node should follow an indication from a UE and retain the UE in an inactive state, or transition a UE into a connected state, remains therefore difficult to resolve.

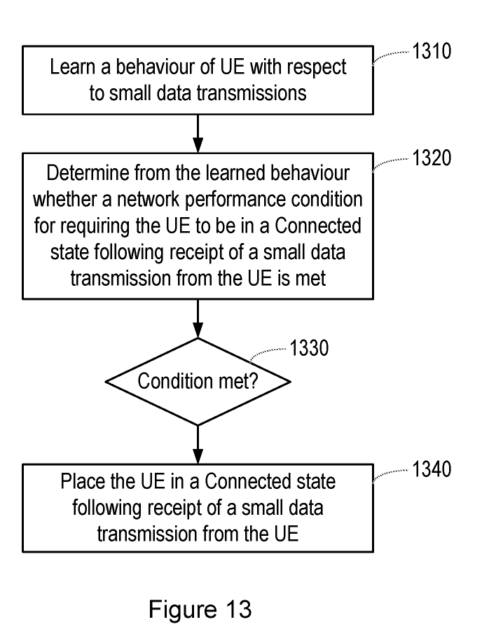

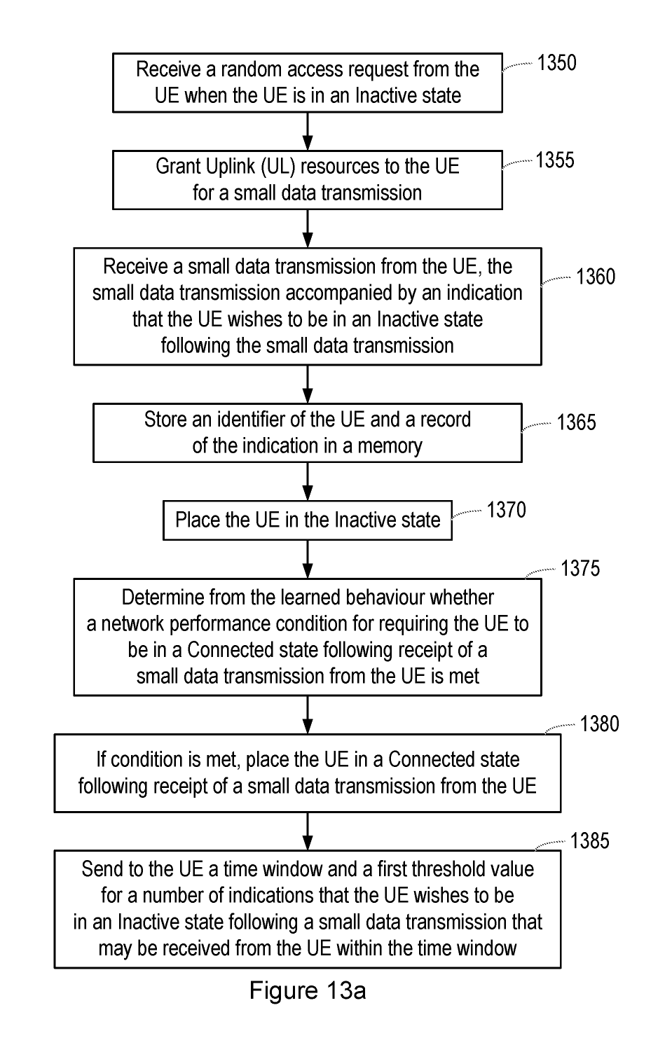

Examples of the present disclosure address this question by assuming that UE indications may not always be trusted, and by allowing for the network to decide whether it should keep a UE in an inactive state or transition it to a connected state. Examples of the present disclosure thus provide a method for managing a Radio Resource Control (RRC) state of a User Equipment (UE). A flow chart illustrating process steps in such a method is illustrated in FIG. 13. Referring to FIG. 13, in a first step 1310, the method comprises learning a behaviour of the UE with respect to small data transmissions. The method then comprises, in step 1320, determining from the learned behaviour whether a network performance condition for requiring the UE to be in a Connected state following receipt of a small data transmission from the UE is met. The method then comprises, if the condition is met in step 1330, placing the UE in a Connected state following receipt of a small data transmission from the UE in step 1340.

FIG. 13a is a flow chart, illustrating in more detail an example of a method for managing a Radio Resource Control (RRC) state of a User Equipment (UE). Referring to FIG. 13a, the method comprises learning a behaviour of the UE with respect to small data transmissions.

A small data transmission may comprise a data transmission by a UE that follows a small data transmission procedure. A small data transmission procedure may comprise, for a UE in an Inactive state: transmitting an amount of data without entering a Connected state. According to examples of the present disclosure, the Inactive state may for example be a newly defined state RRC_INACTIVE or may be the Suspended mode of the state RRC_IDLE.

According to examples of the present disclosure, a small data procedure may be used by UEs in an Inactive state for sending data that is less than some threshold amount.

Transmitting an amount of data without entering a Connected state may comprise at least one of: including the data with Radio Resource Control (RRC) signalling; and transmitting the data on a Contention Based (CB) channel that is reserved for small infrequent data transmissions and may be accessed by UEs in an Inactive state.

Including the data with RRC signalling may comprise including the data with an RRC Connection Re-activation Request.

In one example, the method comprises defining a learning time period, which may be configurable according to network conditions, UE behaviours or other conditions, and further comprises, in step 1355, during the learning time period, granting Uplink (UL) resources to the UE for a small data transmission. In some examples, the grant may be prompted, as shown at step 1350, by receiving a random access request from the UE when the UE is in an Inactive state. In examples of the present disclosure, the method may further comprise checking whether UL resources are available for the UE and only allocating the UL resources to the UE if such resources are available.

The method then comprises, in step 1360, receiving a small data transmission from the UE, the small data transmission accompanied by an indication that the UE wishes to be in an Inactive state following the small data transmission. The indication that the UE wishes to be placed in an Inactive state following the small data transmission may comprise at least one of: an indication that the UE has no further UL data to transmit; and an explicit request to be in the Inactive state. The indication that the UE has no further UL data to transmit may comprise a Buffer Status Report (BSR).

When the UE is in the Inactive state when the small data transmission is received, the indication that the UE wishes to be in an Inactive state following the small data transmission may comprise an indication that the UE wishes to remain in the Inactive state, and placing the UE in the Inactive state may comprise retaining the UE in the inactive state.

In some examples of the present disclosure, the small data transmission may be received from the UE when in an Inactive state with an RRC Connection Resume Request. In other examples, the small data transmission may be received from the UE when in an Inactive state on a Contention Based channel that is reserved for small infrequent data and is accessible by UEs in the Inactive state.

Retaining the UE in the Inactive state may comprise sending an RRC Connection Suspend message to the UE.

As shown at step 1365, the method comprises storing an identifier of the UE and a record of the indication in a memory.

The identifier of the UE may comprise an identifier transmitted with the small data transmission. The identifier may be an identifier transmitted with an RRC Connection Resume Request message from the UE.

The record of the indication may comprise a time at which the indication was received.

In step 1370, the method comprises placing the UE in the Inactive state.

In examples of the present disclosure, learning a behaviour of the UE with respect to small data transmissions may further comprise receiving a data transmission from the UE within a threshold time period of the small data transmission, and storing a record of the receipt of the data transmission within the threshold time period.

In examples of the present disclosure, a behaviour of a UE with respect to small data transmissions may comprise at least one of: a frequency of small data transmissions from the UE accompanied by an indication that the UE wishes to be in an Inactive state following the small data transmission, and/or a frequency of data transmissions received from the UE within a threshold time period of a small data transmission from the UE accompanied by an indication that the UE wishes to be in an Inactive state following the small data transmission.

The method of FIG. 13a comprises, in step 1375, determining from the learned behaviour whether a network performance condition for requiring the UE to be in a Connected state following receipt of a small data transmission from the UE is met.

Determining from the learned behaviour whether a network performance condition for requiring the UE to be in a Connected state following receipt of a small data transmission from the UE is met may comprise determining whether it would be beneficial to network performance for the UE to be in a Connected state.

Additionally or alternatively, determining from the learned behaviour whether a network performance condition for requiring the UE to be in a Connected state following receipt of a small data transmission from the UE is met may comprise determining whether network resources would be more efficiently used with the UE in the Connected state.

Additionally or alternatively, determining from the learned behaviour whether a network performance condition for requiring the UE to be in a Connected state following receipt of a small data transmission from the UE is met may comprise comparing a total number of indications received from the UE within the learning time period to a first threshold value.

Additionally or alternatively, determining from the learned behaviour whether a network performance condition for requiring the UE to be in a Connected state following receipt of a small data transmission from the UE is met may comprise determining that the condition is met if the total number of indications received from the UE within the learning time period exceeds the first threshold value.

Additionally or alternatively, determining from the learned behaviour whether a network performance condition for requiring the UE to be in a Connected state following receipt of a small data transmission from the UE is met may comprise comparing a representation of time between indications received from the UE during the learning time period to a second threshold value. According to examples of the present disclosure, the representation of time may be an average time between indications received from the UE within the learning time period. Determining from the learned behaviour whether a network performance condition for requiring the UE to be in a Connected state following receipt of a small data transmission from the UE is met may then comprise determining that the condition is met if the representation of time between indications received from the UE within the learning time period exceeds the second threshold value.

Additionally or alternatively, determining from the learned behaviour whether a network performance condition for requiring the UE to be in a Connected state following receipt of a small data transmission from the UE is met may comprise using a machine learning model to identify a transmission pattern of the UE and to establish whether the transmission pattern would be more efficiently resourced with the UE in a Connected state than with the UE in an Inactive state. In that case, determining from the learned behaviour whether a network performance condition for requiring the UE to be in a Connected state following receipt of a small data transmission from the UE is met may comprise determining that the condition is met if it is established that the transmission pattern would be more efficiently resourced with the UE in a Connected state than with the UE in an Inactive state.

The method further comprises, in step 1380, if the condition is met, placing the UE in a Connected state following receipt of a small data transmission from the UE.

Placing the UE in a Connected state following receipt of a small data transmission from the UE if the condition is met may comprise ignoring any indication that the UE wishes to be in an Inactive state following the small data transmission that accompanies the small data transmission.

When the UE is in an Inactive state when the small data transmission is received, placing the UE in a Connected state following receipt of a small data transmission from the UE may comprise transitioning the UE from the Inactive state to a Connected state on receipt of a small data transmission from the UE. Transitioning the UE from the Inactive state to the Connected state may comprise sending an RRC Connection Resume message to the UE.

The method may further comprise, in step 1385, sending to the UE a time window and a first threshold value for a number of indications that the UE wishes to be in an Inactive state following a small data transmission that may be received from the UE within the time window. According to examples of the present disclosure, the time window may be the learning time window. The method may then further comprise instructing the UE not to send any further indications that the UE wishes to remain in an Inactive state after a small data transmission during the time window once the first threshold value has been reached.

According to examples of the present disclosure, the method may be implemented in a Radio Access Network, for example in a radio access node. In some examples, the method may be at least partially implemented as a Virtualised Network Function.

Small data transmission is a technical concept under study by the 3GPP and involved companies. For the purposes of the following discussion, a small data transmission comprises a transmission by a UE that follows a small data transmission procedure. A small data transmission procedure comprises a procedure used by UEs in an Inactive state which have an amount of data to transmit which is less than some threshold amount. The precise threshold for the amount of data may vary widely according to different applications, situations and use cases. The procedure allows a UE to send the data without first transitioning to a Connected state. The Connected state is the RRC Connected state, and the Inactive state may be either a newly defined state RRC_INACTIVE, as discussed above, or may be the Suspended mode of the state RRC_IDLE.

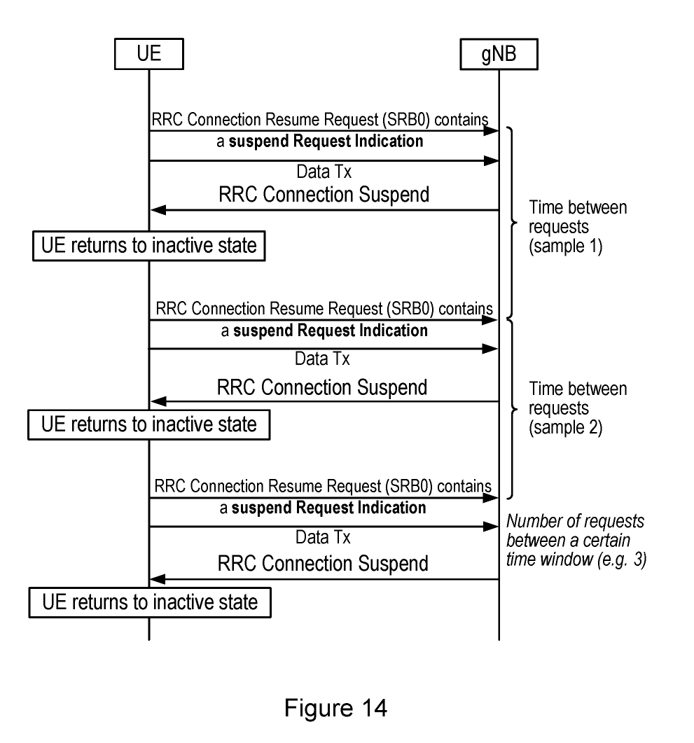

Examples of the present disclosure provide a method, which may be implemented in a network, according to which the network performs a learning phase during a certain time to learn UE behavior with respect to using procedures for small data transmissions. During the learning phase the network may provide additional UL grants for small data transmission together with message 3 (e.g. RRCConnectionResumeRequest), or may provide UL resources for small data transmission via any other mechanism if such UL resources are available. If the small data transmission is accompanied by an indication that the UE wishes to be in an inactive mode, the network stores that information in memory, associated with an identifier of the UE (e.g. the Resume ID in Message 3). The UE indication could be an explicit indication in message 3 that the UE has no more UL data to transmit, such as a buffer status report (BSR), or could be an equivalent indication such as an explicit Suspend Request or remain in RRC_INACTIVE indication. During this learning phase the network may respond as requested by the UE via the indication, that is the network may send the Suspend message to allow the UE remain in RRC_INACTIVE. A signaling diagram for the learning phase is illustrated in FIG. 14.

This learning phase may be configured for a certain time window T by the network. During this learning phase the network may measure and store the time between subsequent UE indications (e.g. Suspend requests indications) and the total number of indications received within the time window. The information stored by the network during the learning phase may enable it to determine if a UE is constantly sending the Suspend Request Indication in message 3 in order to not enter Connected mode for example for the purpose of saving battery life. If this behavior is unwanted by the network, for example if the UE is making very frequent use of small data transmission optimization procedure, this UE may be identified. An indication that a UE wishes to remain in the Inactive state which is received from a UE that has been identified as misusing the small data transmission procedure may be ignored, the network instead triggering the state transition to RRC Connected for example by sending the Resume complete message (message 4 of the Suspend/Resume procedure illustrated in the figures).

On receipt of a small data transmission from a UE that is accompanied by an indication that the UE wishes to remain in the Inactive state, the network may check the UE identifier and check the stored information from the learning phase. For the purpose of detection, the network may define certain thresholds for the number of requests within a time window and for a time between requests or average time between requests. These thresholds could be related to Key Performance Indicators: number of attempts within a given time window T_w and/or average (or other statistic) time between requests. In other examples, more advanced methods such as machine learning may also be used to look for UEs with transmission patterns where it would be beneficial for the network to move the UE to the Connected state instead of following the UEs wish to be retained in Inactive state. Such transmission patterns would include UEs that start larger data transmissions by some small data transmissions and indicate a wish to remain in the Inactive state, for example starting with small TCP requests right before large chunks of data.

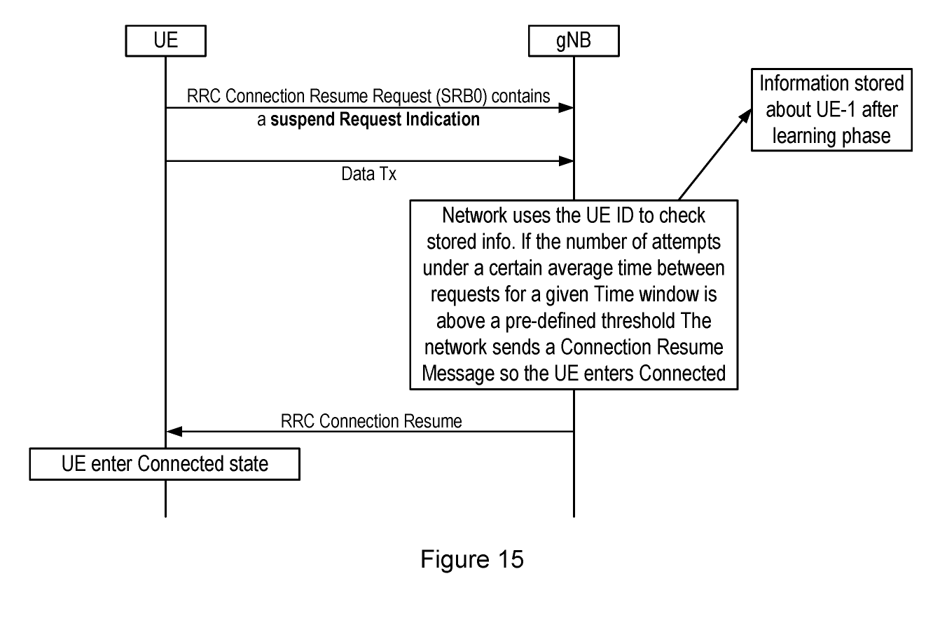

If the network identifies, by comparison to threshold values, through a machine learning identification of traffic patterns or in any other way, that it would be beneficial to the network to place a UE into Connected mode, then the network may begin to reject the indications from the UE that it wishes to remain in the Inactive state (that is to be immediately returned to the inactive state following the transmission, as opposed to completing the transition to the connected state). This process is illustrated in the signaling diagram of FIG. 15.

If the network determines that it would not be particularly beneficial to place a UE in connected mode, for example because the stored values for the UE from the learning phase do not exceed the threshold values, or because the traffic pattern identified by the machine learning model does not indicate that the UE should be placed in Connected state, then the network can treat the UE as suggested by the UE indication, that is immediately suspend the UE to Inactive state.

In some examples of the present disclosure, the network may send to the UE a time window and a first threshold value for a number of indications that the UE wishes to be in an Inactive state following a small data transmission that may be received from the UE within the time window. The network may also instruct the UE not to send any further indications that the UE wishes to remain in an Inactive state after a small data transmission during the time window once the first threshold value has been reached. In further examples, the instruction to the UE may be omitted, and a UE, knowing that indications that it wishes to remain in the Inactive state are likely to be ignored once it has reached the first threshold value and before expiry of the time window, may independently decide not to send such indications so as to improve its statistics.

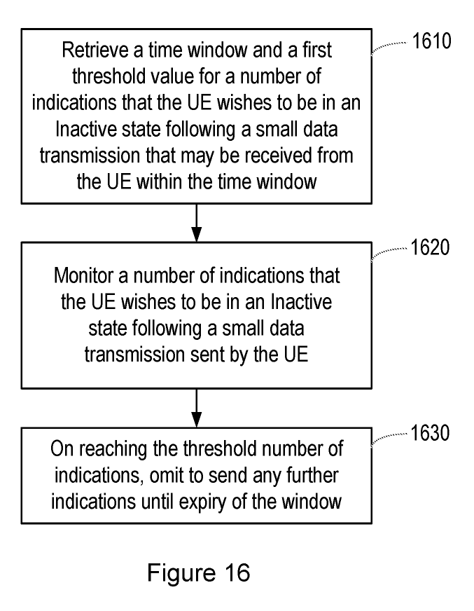

Examples of the present disclosure thus also provide a method for management by a User Equipment (UE) of its Radio Resource Control (RRC) state. A flow chart illustrating process steps in such a method is shown in FIG. 16. Referring to FIG. 16, in a first step 1610 the method comprises retrieving a time window and a first threshold value for a number of indications that the UE wishes to be in an Inactive state following a small data transmission that may be received from the UE within the time window. The method then comprises, in step 1620, monitoring a number of indications that the UE wishes to be in an Inactive state following a small data transmission sent by the UE, and, in step 1630, on reaching the threshold number of indications, omitting to send any further indications until expiry of the time window. The time window and first threshold value may be received from a network node or may be retrieved from a memory.

According to examples of the present disclosure, a small data transmission may comprise a data transmission by a UE that follows a small data transmission procedure. The small data transmission procedure may comprise, for a UE in an Inactive state: transmitting an amount of data without entering a Connected state. Transmitting an amount of data without entering a Connected state may comprise at least one of: including the data with Radio Resource Control (RRC) signalling; and transmitting the data on a Contention Based (CB) channel that is reserved for small infrequent data transmissions and may be accessed by UEs in an Inactive state. Including the data with RRC signalling may comprise including the data with an RRC Connection Re-activation Request.

According to examples of the present disclosure, the Inactive state may for example be a newly defined state RRC_INACTIVE or may be the Suspended mode of the state RRC_IDLE.

According to examples of the present disclosure, a small data procedure may be used by UEs in an Inactive state for sending data that is less than some threshold amount.

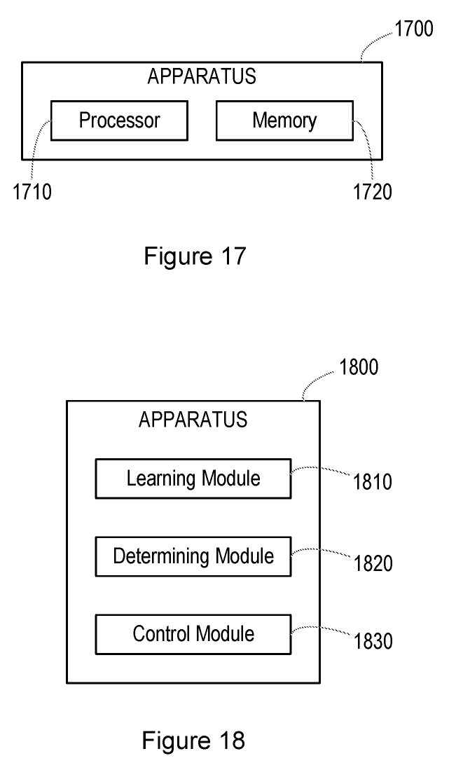

FIG. 17 illustrates a first example of an apparatus 1700 which may carry out methods for managing an RRC state of a UE as discussed above and as illustrated in FIGS. 13 to 15. The apparatus may carry out the methods for example on receipt of suitable instructions from a computer program. Referring to FIG. 17, the apparatus comprises a processor 1710 and a memory 1720. The memory 1720 contains instructions executable by the processor 1710 such that the apparatus 1700 is operative to conduct some or all of the steps of the methods for managing an RRC state of a UE described above and set out in the numbered paragraphs below.

FIG. 18 illustrates an alternative example apparatus 1800, which may implement methods for managing an RRC state of a UE as discussed above and set out in the numbered paragraphs below, for example on receipt of suitable instructions from a computer program. It will be appreciated that the modules illustrated in FIG. 18 may be realised in any appropriate combination of hardware and/or software. For example, the modules may comprise one or more processors and one or more memories containing instructions executable by the one or more processors. The modules may be integrated to any degree.

Referring to FIG. 18, the apparatus 1800 comprises a learning module 1810 for learning a behaviour of the UE with respect to small data transmissions. The apparatus also comprises a determining module 1820 for determining from the learned behaviour whether a network performance condition for requiring the UE to be in a Connected state following receipt of a small data transmission from the UE is met, and a control module 1830 for, if the condition is met, placing the UE in a Connected state following receipt of a small data transmission from the UE.

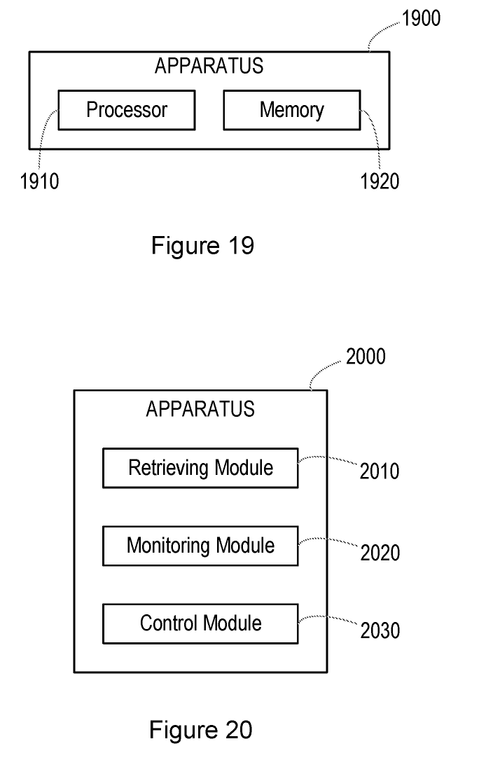

FIG. 19 illustrates a first example of an apparatus 1900 which may carry out a method for management by a UE of its RRC state as discussed above and as illustrated in FIG. 16. The apparatus 1900 may carry out the method for example on receipt of suitable instructions from a computer program. Referring to FIG. 19, the apparatus 1900 comprises a processor 1910 and a memory 1920. The memory 1920 contains instructions executable by the processor 1910 such that the apparatus 1900 is operative to conduct some or all of the steps of the method for management by a UE of its RRC state as discussed above and set out in the numbered paragraphs below.

FIG. 20 illustrates an alternative example apparatus 2000, which may implement a method for management by a UE of its RRC state as discussed above and set out in the numbered paragraphs below, for example on receipt of suitable instructions from a computer program. It will be appreciated that the modules illustrated in FIG. 20 may be realised in any appropriate combination of hardware and/or software. For example, the modules may comprise one or more processors and one or more memories containing instructions executable by the one or more processors. The modules may be integrated to any degree.

Referring to FIG. 20, the apparatus 2000 comprises a retrieving module 2010 for retrieving a time window and a first threshold value for a number of indications that the UE wishes to be in an Inactive state following a small data transmission that may be received from the UE within the time window. The apparatus also comprises a monitoring module 2020 for monitoring a number of indications that the UE wishes to be in an Inactive state following a small data transmission sent by the UE, and a control module 2030 for, on reaching the threshold number of indications, omitting to send any further indications until expiry of the time window.

Aspects of the present disclosure, particularly those described above with respect to FIGS. 13 to 20, thus provide methods enabling a radio access network node, or network function, to monitor and analyse statistics of UE traffic patterns and/or signaling generated with respect to small data transmissions from UEs in an Inactive state during a learning phase. The signaling may include requests from UEs to remain in an Inactive phase after small data transmission. On the basis of this monitoring and analysis, the radio access network node may make a more informed decision as to whether to move the UE to connected state or to let the UE remain in inactive state following subsequent requests.

Examples of the present disclosure enable a network to avoid always complying with an indication from a UE that it wishes to remain in Inactive state after a small data transmission, which indication could be motivated by battery consumption, rather than network resource efficiency, and/or be a result of an incorrect UE estimation of the frequency of packet transmissions. The network may instead make an informed decision as to whether to allow the UE to remain in Inactive state or to transition the UE to Connected state, on the basis of network priorities such as network resource management and network performance.

Returning to FIG. 3, as noted above, a potential scenario is that a UE has small but frequent data, receives an UL resource grant, sends an RRCConnectionResumeRequest message with the data and an indication that the UE does not in fact wish to transition to the Connected state but wishes to remain in the inactive state. The network assumes on the basis of this indication that UE has infrequent data transmissions, which may not always be the case, for example if UEs are not properly optimized to estimate when the traffic is really infrequent and/or if UEs always try to opportunistically remain in Inactive state. In such a situation, the network would be providing UL resources without being able to ensure that the UEs have infrequent data transmissions.

A solution to this issue from the network perspective is described above with respect to FIGS. 13 to 20. Refer again to FIG. 14, which is a signalling diagram illustrating a learning phase of a method proposed above. According to this method, a network node maintains a record of small data transmission behaviour, including for example a number of indications received from a UE in a given time period that the UE wishes to remain in an inactive state. The record may also include a total number of such indications received from a UE within the time period. On the basis of this stored information, the network node may decide to ignore future indications from the UE, and force the UE to transition to a connected state following a small data transition, as illustrated in the signalling diagram of FIG. 15.

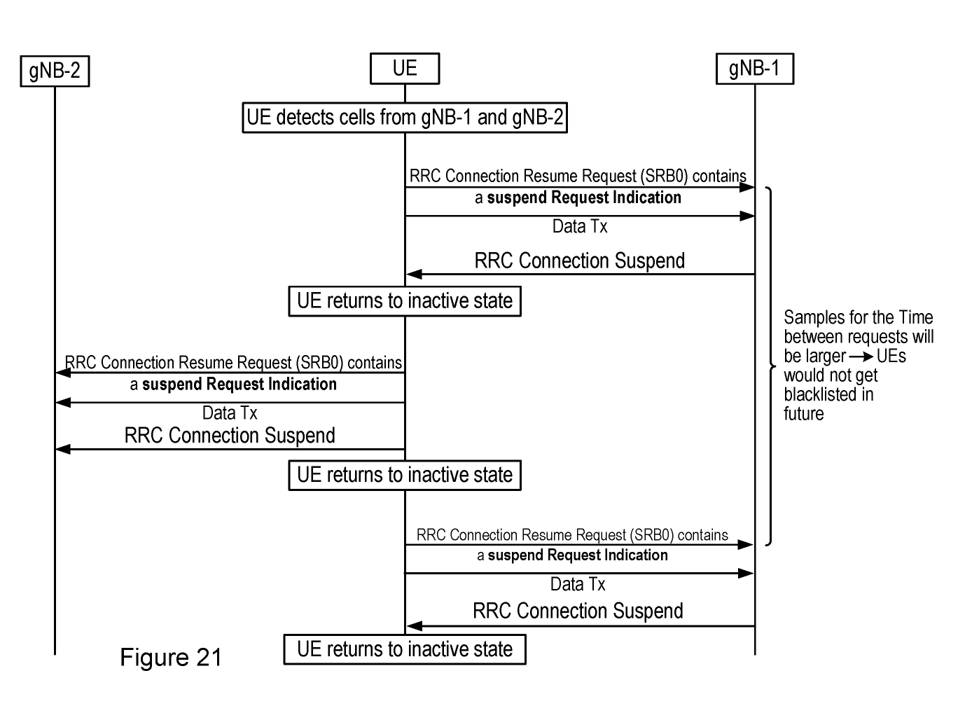

It is to be expected that methods for UEs to circumvent network solutions such as that discussed above and illustrated in FIGS. 14 and 15 will be developed, with the aim of avoiding being forced into the Connected state in order to save battery. One such method is illustrated in the signalling diagram of FIG. 21. Referring to FIG. 21, the method allows for a UE to toggle between different network cells for each small data transmission, selecting for each new small data transmission a different cell to that used for the preceding small data transmission. This can be seen in FIG. 21, in which cell gNB1 is targeted for a first small data transmission, and cell gNB2 is targeted for a second small data transmission, with the UE reverting to cell gNB1 for a third small data transmission. By toggling only between cells that have sufficient signal strength that the transmission of data does not consume an excessive amount of battery, the UE can maintain the advantages of remaining in the Inactive state while avoiding being detected by the network as sending frequent small data transmissions, and so avoiding being forced by the network to transition to the Connected state.

A network operating the solution according to FIGS. 14 and 15 would potentially be unable to detect the frequent small data transmissions of a UE operating according to the method of FIG. 21. In such circumstances, the network may revert to an inefficient handling of resources for the UE, as each network node is unaware of the UE's activities in other cells.

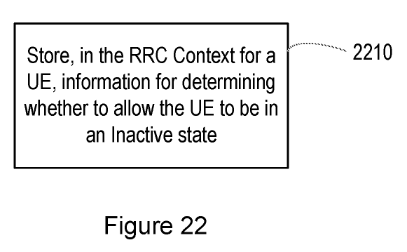

Aspects of the present disclosure provide methods enabling a network to detect frequent small data transmissions from a UE, even when the UE is operating a solution such as that proposed in FIG. 21. A flow chart illustrating process steps in a first such method is illustrated in FIG. 22. Referring to FIG. 22, in a first step 2210, the method comprises storing, in the RRC context for the UE, information for determining whether to allow the UE to be in an Inactive state.

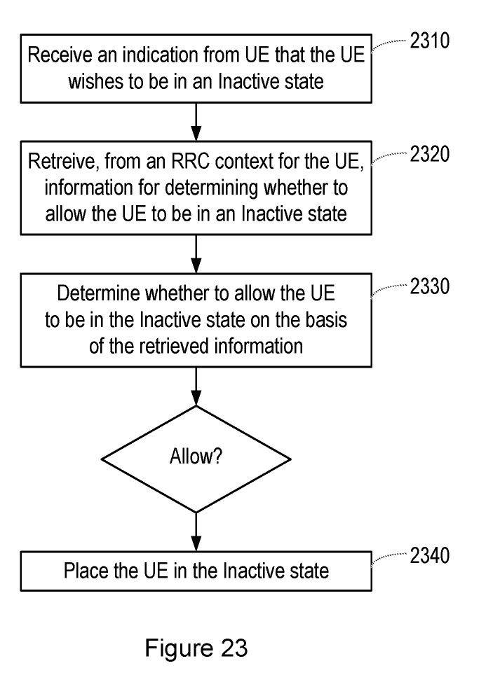

A flow chart illustrating process steps in another such method is illustrated in FIG. 23. Referring to FIG. 23, in a first step 2310, the method comprises receiving an indication from a UE that the UE wishes to be in an Inactive state. The method may further comprise receiving a small data transmission with the indication from the UE.

According to examples of the present disclosure, a small data transmission may comprise a data transmission by a UE that follows a small data transmission procedure. A small data transmission procedure may comprise, for a UE in an Inactive state, transmitting an amount of data without entering a Connected state. According to examples of the present disclosure, the Inactive state may for example be a newly defined state RRC_INACTIVE or may be the Suspended mode of the state RRC_IDLE.

Transmitting an amount of data without entering a Connected state may comprise at least one of: including the data with Radio Resource Control (RRC) signalling; and transmitting the data on a Contention Based (CB) channel that is reserved for small infrequent data transmissions and may be accessed by UEs in an Inactive state. In that case, including the data with RRC signalling may comprise including the data with an RRC Connection Re-activation Request.

Alternatively or additionally, transmitting an amount of data without entering a Connected state may further comprise including with the data an indication that the UE wishes to remain in the Inactive state.

The indication that the UE wishes to be in an Inactive state may comprise at least one of: an indication that the UE has no further UL data to transmit; and an explicit request to be in the Inactive state.

The method then comprises, in step 2320, retrieving, from an RRC context for the UE, information for determining whether to allow the UE to be in an Inactive state.

The information for determining whether to allow the UE to be in an Inactive state may comprise information about Uplink (UL) traffic received from the UE.

The information for determining whether to allow the UE to be in an Inactive state may comprise a representation of a UE traffic pattern, in which case the representation of the UE traffic pattern may comprise a frequency of small data transmissions received from the UE. The frequency of small data transmissions received from the UE may then comprise a representation of time between small data transmissions received from the UE, or a total number of small data transmissions received from the UE within a time window.

Alternatively, or additionally, the representation of the UE traffic pattern may comprise an indication of message size and a message timestamp for transmissions received from the UE, and/or an indication of message size and a message timestamp for small data transmissions received from the UE.

The information for determining whether to allow the UE to be in an Inactive state may comprise one of: an indication that the UE should always be transitioned to a Connected mode after a small data transmission; and an indication that the UE should never be transitioned to a Connected mode after a small data transmission.

In step 2330, the method comprises determining whether to allow the UE to be in the Inactive state on the basis of the retrieved information.

Determining whether to allow the UE to be in the Inactive state on the basis of the retrieved information may comprise determining, on the basis of the retrieved information, whether it would be more beneficial to network performance for the UE to be in a Connected state than in the Inactive state.

Determining whether to allow the UE to be in the Inactive state on the basis of the retrieved information may comprise determining, on the basis of the retrieved information, whether network resources would be more efficiently used with the UE in the Connected state.

The information for determining whether to allow the UE to be in an Inactive state may comprise a frequency of small data transmissions received from the UE, in which case determining whether to allow the UE to be in the Inactive state on the basis of the retrieved information may comprise comparing the frequency of small data transmissions to a threshold value.

In step 2340, the method comprises, if it is determined to allow the UE to be in the Inactive state, placing the UE in the inactive state.

Placing the UE in the inactive state may comprise one of: transitioning the UE to the inactive state; and retaining the UE in the Inactive state.

Placing the UE in the inactive state may comprise sending one of an RRC Connection Suspend message or an RRC Connection inactivation message to the UE.

The method may further comprise, if it is determined not to allow the UE to be in the Inactive state, placing the UE in a Connected state.

Together, the methods of FIGS. 22 and 23 may enable network nodes to transfer between them information relevant to determining whether a UE should be allowed to remain in an Inactive state. Such information may for example include previous UE behaviour with regard to small data transmissions. Network nodes may then take this information into account when deciding whether or not to follow a UE indication that the UE wishes to remain in an Inactive state, rather than basing such a decision only on information concerning the UE's behaviour in that particular cell.

According to examples of the present disclosure, the above methods may be implemented in a Radio Access Network, for example in a radio access node. In some examples, the methods may be at least partially implemented as Virtualised Network Functions.

Small data transmission is a technical concept under study by the 3GPP and involved companies. For the purposes of the following discussion, a small data transmission comprises a transmission by a UE that follows a small data transmission procedure. A small data transmission procedure comprises a procedure used by UEs in an Inactive state which have an amount of data to transmit which is less than some threshold amount. The precise threshold for the amount of data may vary widely according to different applications, situations and use cases. The procedure allows a UE to send the data without first transitioning to a Connected state. The Connected state is the RRC Connected state, and the Inactive state may be either a newly defined state RRC_INACTIVE, as discussed above, or may be the Suspended mode of the state RRC_IDLE.

As discussed above, an RRC context (or Access Stratum (AS) Context) for a UE contains information enabling the UE and the network to resume an RRC connection. This information includes security parameters such as encryption keys, parameters for Signalling Radio Bearers (SRBs) and Data Radio Bearers (DRBs) (Packet Data Convergence Protocol (PDCP) and Radio Link Control (RLC) configurations) and measurement configurations.

According to aspects of the present disclosure, additional information is stored in the RRC context, such information being relevant for determining whether to allow a UE to be in an Inactive state. This information may in some examples be placed in a specified area where network vendors can store any information for any purpose. The area may for example be a specified number of bytes that network vendors can use for any purpose.

Examples of information that might be added to the RRC context include information about Uplink (UL) traffic received from the UE, and/or a representation of a UE traffic pattern. A representation of a UE traffic pattern may comprise a frequency of small data transmissions received from the UE. In some examples, the frequency of small data transmissions received from the UE may be a representation of time between small data transmissions received from the UE. In other examples, the frequency of small data transmissions received from the UE may be a total number of small data transmissions received from the UE within a time window. The small data transmissions may comprise data received with message 3 of the RRC Resume procedure illustrated in FIG. 3, or may comprise any other small data transmission mechanism in the Inactive state. This may include for example sending data and UE identifier on a Contention-Based (CB) channel without RRC signalling. The UE may indicate a wish to remain in the Inactive state following small data transmission by sending a Suspend request indication immediately after the small data transmission, or by sending any other indication that it wishes to remain in inactive state, including for example an indication that it has no more data in its Uplink (UL) buffer.

A representation of a UE traffic pattern may also or alternatively comprise indication of message size (such as a number of bytes) and a message timestamp for transmissions received from the UE. The message size and timestamp tuple may be maintained for all UL transmissions received from the UE, or only for small data transmissions received from the UE.

Another example of information that might be added to the RRC context includes one of an indication that the UE should always be transitioned to a Connected mode after a small data transmission, or an indication that the UE should never be transitioned to a Connected mode after a small data transmission.

The additional information may be stored only in the RRC context on the network side, as it is not to be used by the UE. The additional information may be standardised, so that it can be used also in cases where different eNBs are provided by different vendors.

As discussed above, the additional information in the RRC context can be used by a network node in deciding whether to allow a UE to be in the Inactive state. For example the appropriate RRC context may be fetched by a network node when it receives a small data transmission from a UE, the small data transmission accompanied by an indication that the UE wishes to remain in the Inactive state. The network node may then use the information in the RRC context to determine if it should ignore the indication or allow the UE to remain in the Inactive state.

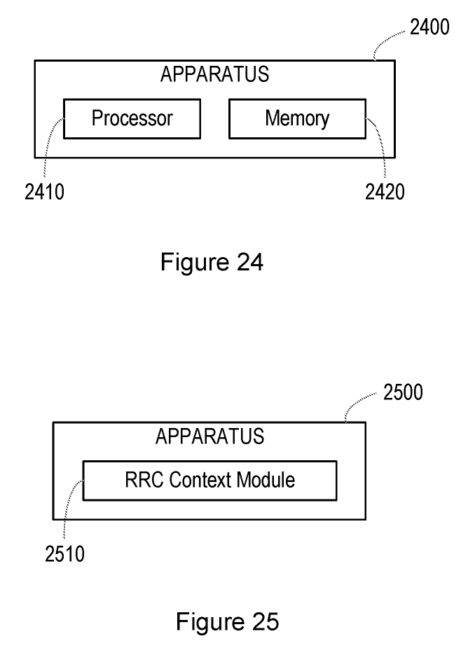

FIG. 24 illustrates a first example of an apparatus 2400 which may carry out methods for managing an RRC context of a UE as discussed above and as illustrated in FIG. 22. The apparatus 2400 may carry out the methods for example on receipt of suitable instructions from a computer program. Referring to FIG. 24, the apparatus 2400 comprises a processor 2410 and a memory 2420. The memory 2420 contains instructions executable by the processor 2410 such that the apparatus 2400 is operative to conduct some or all of the steps of the methods for managing an RRC context of a UE described above and set out in the numbered paragraphs below.

FIG. 25 illustrates an alternative example apparatus 2500, which may implement methods for managing an RRC context of a UE as discussed above and set out in the numbered paragraphs below, for example on receipt of suitable instructions from a computer program. It will be appreciated that the modules illustrated in FIG. 25 may be realised in any appropriate combination of hardware and/or software. For example, the modules may comprise one or more processors and one or more memories containing instructions executable by the one or more processors. The modules may be integrated to any degree.

Referring to FIG. 25, the apparatus 2500 comprises an RRC context module 2510 for storing in the RRC context for the UE information for determining whether to allow the UE to be in an Inactive state.

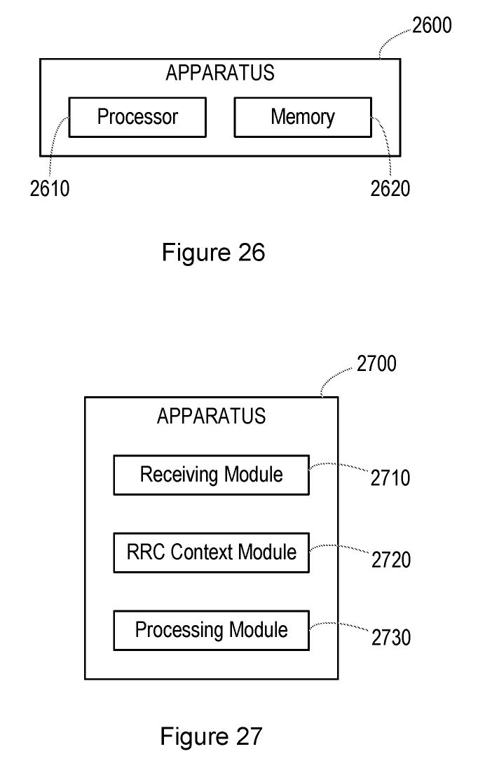

FIG. 26 illustrates a first example of an apparatus 2600 which may carry out a method for managing an RRC state of a UE as discussed above and as illustrated in FIG. 23. The apparatus 2600 may carry out the method for example on receipt of suitable instructions from a computer program. Referring to FIG. 26, the apparatus 2600 comprises a processor 2610 and a memory 2620. The memory 2620 contains instructions executable by the processor 2610 such that the apparatus 2600 is operative to conduct some or all of the steps of the method for managing an RRC state of a UE as discussed above and set out in the numbered paragraphs below.

FIG. 27 illustrates an alternative example apparatus 2700, which may implement a method for managing an RRC state of a UE as discussed above and set out in the numbered paragraphs below, for example on receipt of suitable instructions from a computer program. It will be appreciated that the modules illustrated in FIG. 27 may be realised in any appropriate combination of hardware and/or software. For example, the modules may comprise one or more processors and one or more memories containing instructions executable by the one or more processors. The modules may be integrated to any degree.

Referring to FIG. 27, the apparatus 2700 comprises a receiving module 2710 for receiving an indication from the UE that the UE wishes to be in an Inactive state, and an RRC context module 2720 for retrieving, from an RRC context for the UE, information for determining whether to allow the UE to be in an Inactive state. The apparatus 2700 also comprises a processing module 2730 for determining whether to allow the UE to be in the Inactive state on the basis of the retrieved information, and, if it is determined to allow the UE to be in the Inactive state, for placing the UE in the inactive state.

Aspects of the present disclosure, particularly described above with respect to FIGS. 21 to 27, thus provide methods according to which an RRC context may be updated with information enabling a network node to determine if the UE should be allowed to be in an Inactive state. The information may relate to a historical traffic pattern for the UE. The information may be specified with different granularity, including for example a set of message size and timestamp tuples or frequencies of small data transmissions within a time window. Storing such information in an RRC context means that this information can be transferred between eNBs or gNBs, for example when a UE tries to perform a small data transmission in an eNB where there is no historical information. The network would thus be able to detect a UE that was toggling between different network nodes for its small data transmissions in order to disguise frequent small data transmissions. Based on the information in the RRC context, the network nodes would be able to identify such UEs, and ignore, as appropriate, their indications that they wish to remain in the Inactive state. In this manner, the network may manage network resources more efficiently for UEs with frequent small data transmissions.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Various embodiments of the present disclosure are set out in the following paragraphs:

1. A method for managing a Radio Resource Control (RRC) state of a User Equipment (UE), the method comprising:
learning a behaviour of the UE with respect to small data transmissions;

determining from the learned behaviour whether a network performance condition for requiring the UE to be in a Connected state following receipt of a small data transmission from the UE is met; and

if the condition is met, placing the UE in a Connected state following receipt of a small data transmission from the UE.

In examples of the present disclosure, a behaviour of a UE with respect to small data transmissions may comprise at least one of: a frequency of small data transmissions from the UE accompanied by an indication that the UE wishes to be in an Inactive state following the small data transmission, and/or a frequency of data transmissions received from the UE within a threshold time period of a small data transmission from the UE accompanied by an indication that the UE wishes to be in an Inactive state following the small data transmission.

2. A method according to paragraph 1, wherein a small data transmission comprises a data transmission by a UE that follows a small data transmission procedure.

3. A method according to paragraph 2, wherein a small data transmission procedure comprises, for a UE in an Inactive state:
transmitting an amount of data without entering a Connected state.

According to examples of the present disclosure, the Inactive state may for example be a newly defined state RRC_INACTIVE or may be the Suspended mode of the state RRC_IDLE.

According to examples of the present disclosure, a small data procedure may be used by UEs in an Inactive state for sending data that is less than some threshold amount.

4. A method according to paragraph 3, wherein transmitting an amount of data without entering a Connected state comprises at least one of:
including the data with Radio Resource Control (RRC) signalling;
transmitting the data on a Contention Based (CB) channel that is reserved for small infrequent data transmissions and is accessible by UEs in an Inactive state.

5. A method according to paragraph 4, wherein including the data with RRC signalling comprises including the data with an RRC Connection Re-activation Request.

6. A method according to any one of the preceding paragraphs, wherein learning a behaviour of the UE with respect to small data transmissions comprises, during a learning time period:
granting Uplink (UL) resources to the UE for a small data transmission;
receiving a small data transmission from the UE, the small data transmission accompanied by an indication that the UE wishes to be in an Inactive state following the small data transmission; and
placing the UE in the Inactive state.

7. A method according to paragraph 6, wherein learning a behaviour of the UE with respect to small data transmissions further comprises, during the learning time period:
storing an identifier of the UE and a record of the indication in a memory.

In examples of the present disclosure, learning a behaviour of the UE with respect to small data transmissions may further comprise receiving a data transmission from the UE within a threshold time period of the small data transmission, and storing a record of the receipt of the data transmission within the threshold time period.

In examples of the present disclosure, the learning time period may be configurable according to network conditions, UE behaviours or other conditions.

In examples of the present disclosure, the method may further comprise checking whether UL resources are available for the UE and only allocating the UL resources to the UE if such resources are available.

8. A method according to paragraph 6 or 7, wherein the indication that the UE wishes to be placed in an Inactive state following the small data transmission comprises at least one of:
an indication that the UE has no further UL data to transmit;
an explicit request to be in the Inactive state.

According to examples of the present disclosure, an indication that the UE has no further UL data to transmit may comprise a Buffer Status Report (BSR).

9. A method according to any one of paragraphs 6 to 8, wherein the UE is in the Inactive state when the small data transmission is received, wherein the indication that the UE wishes to be in an Inactive state following the small data transmission comprises an indication that the UE wishes to remain in the Inactive state, and wherein placing the UE in the Inactive state comprises retaining the UE in the inactive state.

In some examples of the present disclosure, the small data transmission may be received from the UE when in an Inactive state with an RRC Connection Resume Request. In other examples, the small data transmission may be received from the UE when in an Inactive state on a Contention Based channel that is reserved for small infrequent data and is accessible by UEs in the Inactive state.

10. A method according to paragraph 9, wherein retaining the UE in the Inactive state comprises sending an RRC Connection Suspend message to the UE.

11. A method according to any one of paragraphs 6 to 10, wherein learning a behaviour of the UE with respect to small data transmissions further comprises, during the learning time period:
receiving a random access request from the UE when the UE is in an Inactive state.

In examples of the present disclosure, the random access request may be received before grant of the UL resources and may prompt the grant of the UL resources.

12. A method according to any one of paragraphs 6 to 11, wherein the identifier of the UE comprises an identifier transmitted with the small data transmission.

In examples of the present disclosure, the identifier may be an identifier transmitted with an RRC Connection Resume Request message from the UE.

13. A method according to any one of paragraphs 6 to 12, wherein the record of the indication comprises a time at which the indication was received.

14. A method according to any one of the preceding paragraphs, wherein determining from the learned behaviour whether a network performance condition for requiring the UE to be in a Connected state following receipt of a small data transmission from the UE is met comprises determining whether it would be beneficial to network performance for the UE to be in a Connected state.

15. A method according to any one of the preceding paragraphs, wherein determining from the learned behaviour whether a network performance condition for requiring the UE to be in a Connected state following receipt of a small data transmission from the UE is met comprises determining whether network resources would be more efficiently used with the UE in the Connected state.

16. A method according to any one of paragraphs 6 to 15, wherein determining from the learned behaviour whether a network performance condition for requiring the UE to be in a Connected state following receipt of a small data transmission from the UE is met comprises comparing a total number of indications received from the UE within the learning time period to a first threshold value.

17. A method according to paragraph 16, wherein determining from the learned behaviour whether a network performance condition for requiring the UE to be in a Connected state following receipt of a small data transmission from the UE is met comprises determining that the condition is met if the total number of indications received from the UE within the learning time period exceeds the first threshold value.

18. A method according to any one of the paragraphs 6 to 17, wherein determining from the learned behaviour whether a network performance condition for requiring the UE to be in a Connected state following receipt of a small data transmission from the UE is met comprises comparing a representation of time between indications received from the UE during the learning time period to a second threshold value.

According to examples of the present disclosure, the representation of time may be an average time between indications received from the UE within the learning time period.

19. A method according to paragraph 18, wherein determining from the learned behaviour whether a network performance condition for requiring the UE to be in a Connected state following receipt of a small data transmission from the UE is met comprises determining that the condition is met if the representation of time between indications received from the UE within the learning time period exceeds the second threshold value.

20. A method according to any one of the preceding paragraphs, wherein determining from the learned behaviour whether a network performance condition for requiring the UE to be in a Connected state following receipt of a small data transmission from the UE is met comprises using a machine learning model to identify a transmission pattern of the UE and to establish whether the transmission pattern would be more efficiently resourced with the UE in a Connected state than with the UE in an Inactive state.

21. A method according to paragraph 20, wherein determining from the learned behaviour whether a network performance condition for requiring the UE to be in a Connected state following receipt of a small data transmission from the UE is met comprises determining that the condition is met if it is established that the transmission pattern would be more efficiently resourced with the UE in a Connected state than with the UE in an Inactive state.

22. A method according to any one of the preceding paragraphs, wherein placing the UE in a Connected state following receipt of a small data transmission from the UE if the condition is met comprises ignoring any indication that the UE wishes to be in an Inactive state following the small data transmission that accompanies the small data transmission.

23. A method according to any one of the preceding paragraphs, wherein the UE is in an Inactive state when the small data transmission is received, and wherein placing the UE in a Connected state following receipt of a small data transmission from the UE comprises transitioning the UE from the Inactive state to a Connected state on receipt of a small data transmission from the UE.

24. A method according to paragraph 23, wherein transitioning the UE from the Inactive state to the Connected state comprises sending an RRC Connection Resume message to the UE.

25. A method according to any one of the preceding paragraphs, further comprising:
sending to the UE a time window and a first threshold value for a number of indications that the UE wishes to be in an Inactive state following a small data transmission that may be received from the UE within the time window.

According to examples of the present disclosure, the time window may be the learning time window.

26. A method according to paragraph 25, further comprising:

p1 the UE not to send any further indications that the UE wishes to remain in an Inactive state after a small data transmission during the time window once the first threshold value has been reached.

According to examples of the present disclosure, the method may be implemented in a Radio Access Network, for example in a radio access node. In some examples, the method may be at least partially implemented as a Virtualised Network Function.

27. A method for management by a User Equipment (UE) of its Radio Resource Control (RRC) state, the method comprising:
retrieving a time window and a first threshold value for a number of indications that the UE wishes to be in an Inactive state following a small data transmission that may be received from the UE within the time window;
monitoring a number of indications that the UE wishes to be in an Inactive state following a small data transmission sent by the UE; and
on reaching the threshold number of indications, omitting to send any further indications until expiry of the time window.

According to examples of the present disclosure, a small data transmission may comprise a transmission as defined in any one of paragraphs 2 to 5 above.

28. A method according to paragraph 27, wherein retrieving a time window and a first threshold value for a number of indications that the UE wishes to be in an Inactive state following a small data transmission that may be received from the UE within the time window comprises receiving the time window and the threshold number of indications from a network node.

29. A method according to paragraph 28, wherein retrieving a time window and a first threshold value for a number of indications that the UE wishes to be in an Inactive state following a small data transmission that may be received from the UE within the time window comprises retrieving the time window and the threshold number of indications from a memory.

30. A computer program comprising instructions which, when executed on at least one processor, cause the at least one processor to carry out a method according to any one of the preceding paragraphs.

31. A carrier containing a computer program according to paragraph 30, wherein the carrier comprises one of an electronic signal, optical signal, radio signal or computer readable storage medium.

32. A computer program product comprising non transitory computer readable media having stored thereon a computer program according to paragraph 30.

33. Apparatus for managing a Radio Resource Control (RRC) state of a User Equipment (UE), the apparatus comprising a processor and a memory, the memory containing instructions executable by the processor such that the apparatus is operable to:
learn a behaviour of the UE with respect to small data transmissions;
determine from the learned behaviour whether a network performance condition for requiring the UE to be in a Connected state following receipt of a small data transmission from the UE is met; and
if the condition is met, place the UE in a Connected state following receipt of a small data transmission from the UE.

34. Apparatus for managing a Radio Resource Control (RRC) state of a User Equipment (UE), the apparatus configured to:
learn a behaviour of the UE with respect to small data transmissions;

p1 from the learned behaviour whether a network performance condition for requiring the UE to be in a Connected state following receipt of a small data transmission from the UE is met; and
if the condition is met, place the UE in a Connected state following receipt of a small data transmission from the UE.

35. Apparatus for managing a Radio Resource Control (RRC) state of a User Equipment (UE), the apparatus comprising:
a learning module for learning a behaviour of the UE with respect to small data transmissions;
a determining module for determining from the learned behaviour whether a network performance condition for requiring the UE to be in a Connected state following receipt of a small data transmission from the UE is met; and
a control module for, if the condition is met, placing the UE in a Connected state following receipt of a small data transmission from the UE.

36. Apparatus for management by a User Equipment (UE) of its Radio Resource Control (RRC) state, the apparatus comprising a processor and a memory, the memory containing instructions executable by the processor such that the apparatus is operable to:
retrieve a time window and a first threshold value for a number of indications that the UE wishes to be in an Inactive state following a small data transmission that may be received from the UE within the time window;
monitor a number of indications that the UE wishes to be in an Inactive state following a small data transmission sent by the UE; and
on reaching the threshold number of indications, omit to send any further indications until expiry of the time window.

37. Apparatus for management by a User Equipment (UE) of its Radio Resource Control (RRC) state, the apparatus configured to:
retrieve a time window and a first threshold value for a number of indications that the UE wishes to be in an Inactive state following a small data transmission that may be received from the UE within the time window;
monitor a number of indications that the UE wishes to be in an Inactive state following a small data transmission sent by the UE; and
on reaching the threshold number of indications, omit to send any further indications until expiry of the time window.

38. Apparatus for management by a User Equipment (UE) of its Radio Resource Control (RRC) state, the apparatus comprising:
a retrieving module for retrieving a time window and a first threshold value for a number of indications that the UE wishes to be in an Inactive state following a small data transmission that may be received from the UE within the time window;
a monitoring module for monitoring a number of indications that the UE wishes to be in an Inactive state following a small data transmission sent by the UE; and
a control module for, on reaching the threshold number of indications, omitting to send any further indications until expiry of the time window.

39. A method for managing a Radio Resource Control (RRC) context of a User Equipment (UE), the method comprising:
storing, in the RRC context for the UE, information for determining whether to allow the UE to be in an Inactive state.

40. A method according to paragraph 39, wherein the information for determining whether to allow the UE to be in an Inactive state comprises information about Uplink (UL) traffic received from the UE.

41. A method according to paragraph 39 or 40, wherein the information for determining whether to allow the UE to be in an Inactive state comprises a representation of a UE traffic pattern.

42. A method according to paragraph 41, wherein the representation of a UE traffic pattern comprises a frequency of small data transmissions received from the UE.

43. A method according to paragraph 42, wherein a small data transmission comprises a data transmission by a UE that follows a small data transmission procedure.

44. A method according to paragraph 43, wherein a small data transmission procedure comprises, for a UE in an Inactive state:
transmitting an amount of data without entering a Connected state.

According to examples of the present disclosure, the Inactive state may for example be a newly defined state RRC_INACTIVE or may be the Suspended mode of the state RRC_IDLE.

45. A method according to paragraph 44, wherein transmitting an amount of data without entering a Connected state comprises at least one of:
including the data with Radio Resource Control (RRC) signalling;
transmitting the data on a Contention Based (CB) channel that is reserved for small infrequent data transmissions and is accessible by UEs in an Inactive state.

46. A method according to paragraph 45, wherein including the data with RRC signalling comprises including the data with an RRC Connection Re-activation Request.

47. A method according to paragraph 45 or 46, wherein transmitting an amount of data without entering a Connected state further comprises including with the data an indication that the UE wishes to remain in the Inactive state.

According to examples of the present disclosure, the indication may be included with the RRC Connection Re-activation Request.

48. A method according to any one of claims 42 to 47, wherein the frequency of small data transmissions received from the UE comprises a representation of time between small data transmissions received from the UE.

49. A method according to any one of claims 42 to 47, wherein the frequency of small data transmissions received from the UE comprises a total number of small data transmissions received from the UE within a time window.

50. A method according to any one of paragraphs 41 to 49, wherein the representation of a UE traffic pattern comprises an indication of message size and a message timestamp for transmissions received from the UE.

51. A method according to paragraph 41 to 50, wherein the representation of a UE traffic pattern comprises an indication of message size and a message timestamp for small data transmissions received from the UE.

52. A method according to any one of paragraphs 39 to 51, wherein the information for determining whether to allow the UE to be in an Inactive state comprises one of:
an indication that the UE should always be transitioned to a Connected mode after a small data transmission;
an indication that the UE should never be transitioned to a Connected mode after a small data transmission.

53. A method for managing a Radio Resource Control (RRC) state of a User Equipment (UE), the method comprising:
receiving an indication from the UE that the UE wishes to be in an Inactive state;
retrieving, from an RRC context for the UE, information for determining whether to allow the UE to be in an Inactive state;
determining whether to allow the UE to be in the Inactive state on the basis of the retrieved information; and
if it is determined to allow the UE to be in the Inactive state, placing the UE in the inactive state.

According to examples of the present disclosure, the information for determining whether to allow the UE to be in an Inactive state may take different forms as set out in any one of paragraphs 40 to 52 above.

54. A method according to paragraph 53, further comprising, if it is determined not to allow the UE to be in the Inactive state, placing the UE in a Connected state.

55. A method according to paragraph 53 or 54, further comprising receiving a small data transmission with the indication from the UE.

According to examples of the present disclosure, a small data transmission may comprise a transmission as set out in any one of paragraphs 43 to 47 above.

56. A method according to any one of paragraphs 53 to 55, wherein the indication that the UE wishes to be in an Inactive state comprises at least one of:
an indication that the UE has no further UL data to transmit;
an explicit request to be in the Inactive state.

57. A method according to any one of paragraphs 53 to 56, wherein placing the UE in the inactive state comprises one of:
transitioning the UE to the inactive state;
retaining the UE in the Inactive state.

58. A method according to any one of paragraphs 53 to 57, wherein placing the UE in the inactive state comprises sending one of an RRC Connection Suspend message or an RRC Connection in-activation message to the UE.

59. A method according to any one of paragraphs 53 to 58, wherein determining whether to allow the UE to be in the Inactive state on the basis of the retrieved information comprises determining, on the basis of the retrieved information, whether it would be more beneficial to network performance for the UE to be in a Connected state than in the Inactive state.

60. A method according to any one of paragraphs 53 to 59, wherein determining whether to allow the UE to be in the Inactive state on the basis of the retrieved information comprises determining, on the basis of the retrieved information, whether network resources would be more efficiently used with the UE in the Connected state.

61. A method according to any one of paragraphs 53 to 60, wherein the information for determining whether to allow the UE to be in an Inactive state comprises a frequency of small data transmissions received from the UE, and wherein determining whether to allow the UE to be in the Inactive state on the basis of the retrieved information comprises comparing the frequency of small data transmissions to a threshold value.

According to examples of the present disclosure, the above methods may be implemented in a Radio Access Network, for example in a radio access node. In some examples, the methods may be at least partially implemented as Virtualised Network Functions.

62. A computer program comprising instructions which, when executed on at least one processor, cause the at least one processor to carry out a method according to any one of paragraphs 39 to 61.

63. A carrier containing a computer program according to paragraph 62, wherein the carrier comprises one of an electronic signal, optical signal, radio signal or computer readable storage medium.

64. A computer program product comprising non transitory computer readable media having stored thereon a computer program according to paragraph 62.

65. Apparatus for managing a Radio Resource Control (RRC) context of a User Equipment (UE), the apparatus comprising a processor and a memory, the memory containing instructions executable by the processor such that the apparatus is operable to:
store in the RRC context for the UE information for determining whether to allow the UE to be in an Inactive state.

66. Apparatus for managing a Radio Resource Control (RRC) context of a User Equipment (UE), the apparatus configured to:
store in the RRC context for the UE information for determining whether to allow the UE to be in an Inactive state.

67. Apparatus for managing a Radio Resource Control (RRC) context of a User Equipment (UE), the apparatus comprising:
an RRC context module for storing in the RRC context for the UE information for determining whether to allow the UE to be in an Inactive state.

68. Apparatus for managing a Radio Resource Control (RRC) state of a User Equipment (UE), the apparatus comprising a processor and a memory, the memory containing instructions executable by the processor such that the apparatus is operable to:
receive an indication from the UE that the UE wishes to be in an Inactive state;
retrieve, from an RRC context for the UE, information for determining whether to allow the UE to be in an Inactive state;
determine whether to allow the UE to be in the Inactive state on the basis of the retrieved information; and
if it is determined to allow the UE to be in the Inactive state, place the UE in the inactive state.

69. Apparatus for managing a Radio Resource Control (RRC) state of a User Equipment (UE), the apparatus configured to:
receive an indication from the UE that the UE wishes to be in an Inactive state;
retrieve, from an RRC context for the UE, information for determining whether to allow the UE to be in an Inactive state;
determine whether to allow the UE to be in the Inactive state on the basis of the retrieved information; and
if it is determined to allow the UE to be in the Inactive state, place the UE in the inactive state.

70. Apparatus for managing a Radio Resource Control (RRC) state of a User Equipment (UE), the apparatus comprising:
a receiving module for receiving an indication from the UE that the UE wishes to be in an Inactive state;
an RRC context module for retrieving, from an RRC context for the UE, information for determining whether to allow the UE to be in an Inactive state;
a processing module for determining whether to allow the UE to be in the Inactive state on the basis of the retrieved information; and
if it is determined to allow the UE to be in the Inactive state, placing the UE in the inactive state.

1-35. (canceled)

36. A method for managing small data transmissions from a User Equipment (UE), the method comprising:
configuring the UE with a timer, wherein the timer expires after a threshold period of time; and
instructing the UE to:
reset the timer after each small data transmission by the UE; and
once the timer has been reset, refrain from making any additional small data transmissions until the timer has expired.

37. The method of claim 36, wherein a small data transmission comprises a data transmission by a UE that follows a small data transmission procedure.

38. The method of claim 37, wherein a small data transmission procedure comprises, for a UE in an Inactive state:
transmitting an amount of data without entering a Connected state.

39. The method of claim 38, wherein transmitting an amount of data without entering a Connected state comprises at least one of:
including the data with Radio Resource Control (RRC) signaling;
transmitting the data on a Contention Based (CB) channel that is reserved for small infrequent data transmissions and is accessible by UEs in an Inactive state.

40. The method of claim 39, wherein including the data with RRC signaling comprises including the data with an RRC Connection Re-activation Request.

41. The method of claim 40, wherein transmitting an amount of data without entering a Connected state further comprises including with the RRC Connection Re-activation request an indication that the UE wishes to remain in the Inactive state.

42. The method of claim 36, wherein configuring the UE with a timer comprises one of:
including configuration details for the timer with system information broadcast within a cell in which the UE is located; and
including configuration details for the timer with dedicated signaling for the UE.

43. The method of claim 42, wherein including configuration details for the timer with dedicated signaling for the UE comprises including the configuration details with RRC signaling for the UE.

44. The method of claim 36, further comprising:
updating the threshold period of time after which the timer expires in accordance with at least one of:
network conditions,
network load, UE traffic pattern.

45. A method for a User Equipment (UE) to manage its small data transmissions, the method comprising:
obtaining configuration details for a timer, wherein the timer expires after a threshold period of time;
resetting the timer after sending a small data transmission; and
refraining from sending any additional small data transmissions until the timer has expired.

46. The method of claim 45, wherein a small data transmission comprises a data transmission by a UE that follows a small data transmission procedure.

47. The method of claim 46, wherein a small data transmission procedure comprises, for a UE in an Inactive state:
transmitting an amount of data without entering a Connected state.

48. The method of claim 47, wherein transmitting an amount of data without entering a Connected state comprises at least one of:
including the data with Radio Resource Control (RRC) signaling;
transmitting the data on a Contention Based (CB) channel that is reserved for small infrequent data transmissions and is accessible by UEs in an Inactive state.

49. The method of claim 45, further comprising:
identifying data for transmission, wherein the data is suitable for small data transmission;
checking whether the timer is running; and
if the timer is running, refraining from sending the data as a small data transmission.

50. The method of claim 49, wherein refraining from sending the data as a small data transmission comprises:
determining whether delaying transmission of the data until the timer has expired is acceptable, and
if delaying transmission of the data until the timer has expired is acceptable:
waiting for the timer to expire; and
when the timer has expired, transmitting the data as a small data transmission.

51. The method of claim 50, wherein refraining from sending the data as a small data transmission further comprises:
after transmitting the data as a small data transmission, resetting the timer.

52. The method of claim 50, wherein refraining from sending the data as a small data transmission further comprises:
if delaying transmission of the data until the timer has expired is not acceptable:
transmitting the data as an ordinary data transmission.

53. The method of claim 52, wherein an ordinary data transmission comprises a data transmission by a UE that follows an ordinary data transmission procedure.

54. The method of claim 53, wherein an ordinary data transmission procedure comprises, for a UE in an Inactive state:
requesting transition to a Connected state; and
on entering the Connected state, transmitting an amount of data.

55. The method of claim 49, further comprising:
if the timer is not running, sending the data as a small data transmission.

56. An apparatus for managing small data transmissions from a User Equipment (UE), the apparatus comprising a processor and a memory, the memory containing instructions executable by the processor such that the apparatus is operative to:
configure the UE with a timer, wherein the timer expires after a threshold period of time; and
instruct the UE to:
reset the timer after each small data transmission by the UE; and
once the timer has been reset, refrain from making any additional small data transmissions until the timer has expired.

57. The apparatus of claim 56, wherein a small data transmission comprises a data transmission by a UE that follows a small data transmission procedure, and wherein a small data transmission procedure comprises, for a UE in an Inactive state:
transmitting an amount of data without entering a Connected state.

58. The apparatus of claim 56, wherein the memory contains further instructions executable by the processor such that the apparatus is operative to:
update the threshold period of time after which the timer expires in accordance with at least one of:
network conditions,
network load,
UE traffic pattern.

59. An apparatus for a User Equipment (UE) to manage its small data transmissions, the apparatus comprising a processor and a memory, the memory containing instructions executable by the processor such that the apparatus is operative to:
obtain configuration details for a timer, wherein the timer expires after a threshold period of time;
reset the timer after sending a small data transmission; and
refrain from sending any additional small data transmissions until the time has expired.

60. The apparatus of claim 59, wherein the memory contains further instructions executable by the processor such that the apparatus is operative to:
identify data for transmission, wherein the data is suitable for small data transmission;
check whether the timer is running; and
if the timer is running, refrain from sending the data as a small data transmission.

61. The apparatus of claim 59, wherein the apparatus is operative to refrain from sending the data as a small data transmission by:
determining whether delaying transmission of the data until the timer has expired is acceptable, and
if delaying transmission of the data until the timer has expired is acceptable:
waiting for the timer to expire; and
when the timer has expired, transmitting the data as a small data transmission.

62. The apparatus of claim 61, wherein the apparatus is further operative to refrain from sending the data as a small data transmission by:
if delaying transmission of the data until the timer has expired is not acceptable:
transmitting the data as an ordinary data transmission.

63. The apparatus of claim 62, wherein an ordinary data transmission comprises a data transmission by a UE that follows an ordinary data transmission procedure, and wherein an ordinary data transmission procedure comprises, for a UE in an Inactive state:
requesting transition to a Connected state; and
on entering the Connected state, transmitting an amount of data.
